(19) United States
(12) Patent Application Publication
(10) Pub. No.: US 2010/0276484 A1
(43) Pub. Date: Nov. 4, 2010

(54) STAGED TRANSACTION TOKEN FOR MERCHANT RATING

(76) Inventors: Ashim Banerjee, Boulder, CO (US); Dimitrios Hapitas, Scottsdale, AZ (US); Angela M. Schmuck, Mesa, AZ (US); Craig S. Ludwig, Tempe, AZ (US); Amit Bhatnagar, Chandler, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 12/770,483

(22) Filed: Apr. 29, 2010

Related U.S. Application Data
(60) Provisional application No. 61/174,840, filed on May 1, 2009.
(60) Provisional application No. 61/234,230, filed on Aug. 14, 2009.
(60) Provisional application No. 61/245,805, filed on Sep. 25, 2009.

(51) Int. Cl. G06Q 30/00; G06K 5/00

(52) U.S. Cl. 235/379

(57) ABSTRACT

An e-wallet service allows a consumer to retrieve a list of merchants selling goods and services specified by the consumer, see reviews by other consumers who conducted transactions with the merchants on the retrieved list; select a merchant from the retrieved list and an account to pay for a staged transaction and a corresponding token for the staged transaction with the selected merchant, conduct the staged transaction with the merchant by the submission of the token to the merchant as form of payment; and use the token, after conducting the staged transaction with the selected merchant, to gain access to a social media portal and input the consumer's opinion about the selected merchant's performance of the staged transaction.

### CROSS-REFERENCE TO RELATED APPLICATIONS

This application claims priority to, and the benefit of, U.S. Application Ser. No. 61/174,840, titled “Mobile Wallet Web Service,” filed on May 1, 2009, and to U.S. Application Ser. No. 61/234,230, titled “Payroll Deduction Mobile Wallet Web Service With Staged Transaction Thresholding,” filed on Aug. 14, 2009, and to U.S. Application Ser. No. 61/245,805, titled “Third Party Payee Payroll Deduction Mobile Wallet Web Service,” filed on Sep. 25, 2009, each of which is incorporated herein by reference.

### COPYRIGHT NOTICE

This disclosure is protected under United States and International Copyright Laws. A portion of the disclosure of this patent document contains material which is subject to copyright protection. The copyright owner has no objection to the facsimile reproduction by anyone of the patent document or the patent disclosure after formal publication by the US Patent and Trademark Office (USPTO), as it appears in the USPTO patent file or records, but otherwise reserves all copyright rights whatsoever.

### FIELD

The present invention is generally related to a consumer conducting a transaction on an account with a merchant, where the account was issued to the consumer by an issuer, and is more particularly related to the consumer staging the transaction with a corresponding token before conducting the transaction, and then granting the consumer access to a portal using the token after conducting the transaction.

### BACKGROUND

Conducting consumer transactions with cash and bank checks is giving way to a modern trend of conducting cashless transactions. Each cashless transaction is conducted by a consumer with a participating merchant. When the transaction is conducted on an account, the account may have been issued to the consumer by their bank or an issuer. Examples of cashless transactions include credit card transactions, prepaid card transactions, debit card transactions, etc.

When going shopping, a consumer typically takes a wallet or purse. Though often bulky, unwieldy, or unaesthetic to the shopper, the wallet or purse is presently necessary because these hold the various portable consumer payment devices, typically a check book, credit and/or debit cards, which are necessary to conduct cashless transactions. These portable consumer payment devices must also be taken on a shopping trip because they provide a merchant with indicia of the consumer's authority to conduct a transaction with the merchant. An added burden is that the shopper is not able to travel light through various shopping areas at which a shopping bag or parcel containing purchases must be picked up and carried. Also problematic is the opportunity for a thief to steal the wallet or purse while the consumer is engaged in a shopping trip.

Where a consumer does not have authority to conduct a cashless transaction with a participating merchant, fraud and/or identify theft is often involved. For instance, the consumer's wallet or purse may be stolen by another consumer who in turn makes use of the various portable consumer payment devices therein, along with any identification cards also therein, to fraudulently conduct a transaction with a merchant. It would be an advantage in the relevant art for a consumer to be able to shop without carrying a wallet or purse and still be able to conduct cashless transactions with merchants.

### SUMMARY

In one implementation, a request is received to conduct a transaction with a merchant on an account for a purchase of a good or service with an account holder, where the account is issued by an issuer to an account holder, a determination is made whether the request is authorized by the account holder. If the request is authorized by the account holder, a token is sent, in response to the receiving of the request, to a logical address corresponding to the account holder. The token is representative of the account issued by the issuer to the account holder and is sufficient for the merchant in the list to conduct the transaction on the account for the purchase of the good or service. A transmission is received that includes an indicator that the token has been submitted to the one said merchant. A comparison is made to find a difference between the time that the transmission was received and the time that the token was sent to the logical address corresponding to the account holder. This comparison ascertains whether the difference exceeds a predetermined time limit. If difference is not greater than the predetermined time limit, a message is sent to a logical address corresponding to the merchant that authorizes the merchant to conduct the transaction on the account for the purchase of the good or service. After the transaction has been conducted, a confirmation of the transaction can be send to the logical address corresponding to the account holder.

In another implementation, a request is received for a list of merchants each of whom can conduct a transaction on an account for a purchase of a good or service with an account holder, where the account is issued by an issuer to an account holder. The request includes criteria that can be used to determine whether the request is authorized by the account holder. If request is authorized by the account holder, the criteria is used to retrieve the list of merchants, where at least one of the merchants in the list satisfies the criteria. In response to the receiving of the request, the list of merchants is sent to a logical address corresponding to the account holder. A selection is received of one of the merchants in the list. In response to the receiving of the selected merchant, a token is sent to the logical address corresponding to the account holder. The token is representative of the account issued by the issuer and is sufficient for the selected merchant in the list to conduct the transaction on the account for the purchase of the good or service. Thereafter, information is received confirming that the transaction has been conducted by the account holder submitting the token to the selected merchant in the list, and a confirmation of the transaction is sent to the logical address corresponding to the account holder.

In a still further implementation, a method receives criteria in a request for a list of merchants each of whom can conduct a transaction on an account for a purchase of a good or service with an account holder, where the account is issued by an issuer to an account holder. The method determines, using the criteria, whether the request is authorized by the account holder, and if the request is authorized by the account holder, the method: (i) retrieves, using the criteria, the list of merchants, where at least one of the merchants in the list satisfies the criteria, and the list of merchants includes an offer from each merchant in the list for a discount on the transaction conducted on the account by the account holder with the merchant. In response to the receiving of the request, the list of merchants is sent to a logical address corresponding to the account holder. A selection is received of one of the offers from one of the merchants in the list. The method then include sending to the logical address corresponding to the account holder, in response to the receiving of the selection of the one said merchant, a token that is representative of the account issued by the issuer to the logical address corresponding to the account holder. The token is sufficient for the merchant of the selected offer merchant in the list to conduct the transaction on the account for the purchase of the good or service. The token is also associated with the discount of the selected offer from the one merchant in the list. A transmission is received that includes an indicator that the token has been submitted to the one said merchant. The method includes comparing the time that the transmission was received to the time that the token was sent to the logical address corresponding to the account holder to ascertain whether a difference from the comparison exceeds a predetermined time limit. If difference from the comparison is not greater than the predetermined time limit, the method includes sending a message to a logical address corresponding to the merchant who made the selected offer, where the message includes an authorization to conduct the transaction on the account for the purchase of the good or service, and the discount of the selected offer from the corresponding merchant in the list.

In yet another implementation, a method includes receiving a token representative of an account issued by an issuer to an account holder. A determination is made, using the token, whether the token had been submitted to a merchant as a payment on the account for a transaction conducted on the account for a purchase of a good or service. If the token had been submitted to conduct the transaction, the method will allow an evaluation to be received, where the evaluation is of the transaction for the purchase of the good or service from the merchant. The received evaluation is stored, in a database, so as to be associated with the merchant. The database contains a plurality of such merchants and their respective evaluations that had been submitted by other such account holders who had conducted respective transactions with the merchants in the database.

### BRIEF DESCRIPTION OF THE DRAWINGS

Aspects of the present invention will become evident upon reviewing the non-limiting embodiments described in the specification and the claim taken in conjunction with the accompanying figures, wherein like numerals designate like elements.

FIG. 1 is a schematic of an exemplary environment in which a consumer registers to a virtual wallet web service or electronic wallet (‘e-wallet’) web service one or more accounts issued by a bank or an issuer to the consumer;

FIG. 2 illustrates a schematic of an exemplary environment in which the consumer requests and receives tokens corresponding to registered accounts and further corresponding to merchants registered with the e-wallet web service with whom the consumer wishes to conduct cashless transactions;

FIG. 3 is a schematic of an exemplary environment in which the consumer submits one of the tokens to the corresponding merchant to conduct the corresponding cashless transaction, where the cashless transaction is authorized and processed for payment of the merchant on the registered account corresponding to the token;

FIG. 4 illustrates a flow chart of an exemplary method, which can be practiced in the environments of FIGS. 1-3, in which, a consumer registers with an e-wallet web service one or more accounts issued by a bank or an issuer to the consumer, the consumer requests and receives tokens corresponding to registered accounts and further corresponding to merchants registered with the e-wallet web service with whom the consumer wishes to conduct cashless transactions, where the consumer submits one of the tokens to the corresponding merchant to conduct the corresponding cashless transaction, where the cashless transaction is authorized, and where the consumer receives a response upon completion of the corresponding cashless transaction;

FIGS. 5-10 are respective exemplary screen shots for a user interface executing on a client by which a consumer registers one or more accounts issued by a bank or an issuer to the consumer with an e-wallet web service;

FIGS. 11-15 are respective exemplary screen shots for a user interface executing on a client by which a consumer requests and receives tokens corresponding to registered accounts and further corresponding to merchants registered with the e-wallet web service with whom the consumer wishes to conduct cashless transactions;

FIGS. 16-18 are respective exemplary screen shots for a user interface executing on a client operated as a Point Of Service terminal (POS) by which a merchant conducts a cashless transaction with a consumer using a token corresponding to an account issued to the consumer by an issuer, where the token was given to the consumer by an e-wallet web service upon the consumer's selection of the merchant;

FIG. 19 is a schematic of an exemplary environment in which an e-wallet web service conducted in the environments of FIGS. 1-3 facilitates a data mining operation of an e-wallet facilitating entity;

FIG. 20 illustrates a flow chart of an exemplary alternative method, which can be practiced in the environments of FIGS. 1-3 and 19, in which, a consumer registered with an e-wallet web service assess the service, inputs a category of a merchant into a search engine and optionally other search criteria, and receives back a hierarchical list of advertisements from merchants according to the input search criteria, where a token is received by the consumer upon selection of an advertisement in the hierarchical list, and terms and conditions of the selected advertisement for the merchant are associated with the token;

FIG. 21 illustrates a flow chart of an exemplary extension to the method of FIG. 20, where, after the consumer receives the token, other advertisements can also be received by the consumer which, upon selection by the consumer, the terms and conditions thereof are also associated with the token, where the consumer's token is submitted to the selected merchant to conduct the staged transaction subject to the terms and conditions associated with the token as correspond to the selected advertisements, where the e-Wallet facilitating entity receives the token from the merchant to authorization of the staged transaction; and where the cashless transaction is authorized and processed for payment of the merchant on the registered account corresponding to the token;

FIG. 22 illustrates a flow chart of an exemplary extension to the method of FIG. 21, where the consumer accesses a social media portal for the e-wallet service using the token that the consumer used to conduct the staged transaction with the selected merchant, where the consumer rates and comments upon the service within the e-wallet service social media portal, and where the consumer's rating and comments are stored so as to be accessible to other consumers if matching predetermined criteria is met;

FIG. 23 shows an exemplary exploded user interface rendered at on a web enabled computing apparatus that a consumer can use, in accordance with the method of FIG. 20, to input a category of a merchant into a search engine and optionally other search criteria;

FIG. 24 shows an exemplary exploded user interface rendered at on a web enabled computing apparatus that a consumer can use, in accordance with the method of FIG. 20, to see a hierarchical list of advertisements from merchants according to the input search criteria with respect to FIG. 23, where the consumer can select a merchant's advertisement from the list or see reviews and comments of any merchant corresponding to an advertisement in the hierarchical list;

FIG. 25 shows an exemplary exploded user interface rendered at on a web enabled computing apparatus where a consumer, in accordance with the method of FIG. 20, sees ratings and comments from other consumers that have conducted transactions in the past with the merchant in the hierarchical list by using a token received from the e-wallet service to see a hierarchical list of advertisements from merchants according to the input search criteria with respect to FIG. 23, where the consumer can select a merchant's advertisement from the list;

FIG. 26 shows an exemplary exploded user interface rendered at on a web enabled computing apparatus where a consumer, in accordance with the methods of FIGS. 20-21, receives a token and a display of other advertisements for other goods and services sold by the selected merchant for the consumer's further selection and association with the token;

FIG. 27 shows an exemplary exploded user interface rendered at a Point of Service terminal (POS) for use by a consumer to select one or more accounts to be used by the consumer to conduct a staged transaction with a selected merchant and upon which will be conducted the staged transaction in order to pay for one or more items being purchased in the staged transaction conducted in the environment of FIG. 3;

FIG. 28 shows an exemplary exploded user interface rendered at a Point of Service terminal (POS) for use to input one or more tokens submitted by a consumer to the POS and respectively representing accounts selected by the consumer's user of the user interface of FIG. 27, where the selected accounts are to be used to pay for one or more items being purchased in a staged transaction conducted in the environment of FIG. 3;

FIGS. 29a and 29b show, respectively, an exemplary paper receipt and exemplary text messages memorializing a cashless transaction conducted in the environment of FIG. 3;

FIG. 30 shows an exemplary exploded user interface rendered at on a web enabled computing apparatus where a consumer, in accordance with the method of FIG. 21, inputs the token used to conduct the staged transaction in order to further input a rating or review and optionally comments for the staged transaction; and

FIG. 31 shows an exemplary exploded user interface rendered at on a web enabled computing apparatus where a consumer, in accordance with the method of FIG. 21, is offered a consolation token to conduct a future staged transaction in exchange for withholding a previously input rating or review that matches a predetermined criteria.

### DETAILED DESCRIPTION

The present application enables a consumer to make a purchase from a participating merchant without giving the merchant the account information, but rather by using a token that represents the account. By way of example, and not by way of limitation, the consumer enters a store carrying only a cellular telephone. The consumer accesses an e-wallet web service through a browser application executing on the cellular telephone to communicate through a corresponding cellular network to the World Wide Web. The consumer operates the browser application to locate the store as a participating merchant in the e-wallet web service, and requests a ‘token’ for the store using the user interface rendered on the cellular telephone.

In one implementation, the token can be: (i) a string of numbers and/or letters; (ii) a bar code; (iii) a symbol that identifies an account issued by an issuer upon which a transaction with a merchant can be conducted.

In one implementation, the token is a sixteen (16) digit number that mimics an account number of a debit card, gift card, credit card, etc. The token can be within a range of unused Bank Identification Numbers (BIN) of a financial institution and can be compliant with protocol for account numbers, such as being mod 10 checks compliant, satisfying check digit tests, etc. An advantage of the token being a 16-digit number is that a merchant can simply manually enter the 16-digit token using an input device associated with a Point of Service terminal (POS) similar to entering an account number of a cardholder's card. The merchant, in keying in the 16-digit token, would treat the transaction as a ‘card present transaction’, and not as a ‘card not present’ transaction which might otherwise also require a card verification value (e.g., “CVV”. “CVV2”, etc.) to be keyed into the POS. Another advantage of this token being a 16-digit number is that no changes need to be made to software, programming or procedures at the POS. The token is communicated to the merchant's acquirer-processor who facilitates the processing of the 16-digit number token with respect to a corresponding account issued by an issuer. In the event that such a token is requested by a consumer for use at a particular merchant, but the consumer does not present the token to the particular merchant within a predetermined time frame, then the token's eligibility for use by the consumer will be terminated. The terminated token can then be put back into the pool of available 16-digit tokens for use, upon request, by other consumers who have registered with the e-wallet web service. As such, each 16-digit token, as being available as a number having an BIN of a financial institution, is intended to be used by a consumer one time only at a predetermined merchant, which use is limited to a predetermined time from which the token is delivered to the consumer.

The requested token is generated through a collaboration. This collaboration can be among several parties, including the store (e.g., the merchant who is operating the store), an e-wallet web service operated by an e-wallet facilitating entity, and the consumer. The interaction between collaborators results in a token being created. The token that is created will serve as a substitute for an account selected by the consumer upon which to conduct a future transaction within a predetermined time period with the merchant. The token need not represent, but could also represent, a currency amount of the future transaction, or specific or general purchases to be made in the future transaction.

In another implementation, the token requested by a consumer from the e-wallet service is generated as a 16 digit number by the merchant's acquirer processor, or by an agent of the acquirer processor for the purposes of facilitating the merchant's use of the e-wallet service. In this case, the merchant's acquirer processor, or agent thereof, will have set aside one or more specific ranges of 16-digit numbers for use as tokens to be sent, upon request, to consumers who have registered with the e-wallet web service. Again, the 16-digit token, upon receipt by the requesting consumer, can be manually keyed into the merchant's POS, and can be fully compliant with protocol for account numbers, including mod-10 test complaint, check digit test compliant, etc. Another advantage of this token being a 16-digit number is that no changes need to be made to software, programming or procedures at the POS. In the event that such a token is requested by a consumer for use at a particular merchant, but the consumer does not present the token to the particular merchant within a predetermined time frame, then the token's eligibility for use by the consumer will be terminated in accordance with predetermined criteria. The terminated token can then be put back into the pool of available 16-digit tokens for use, upon request, by other consumers who have registered with the e-wallet web service. As such, each 16-digit token, as generated the merchant's acquirer processor or agent thereof, is intended to be used by a consumer one time only at a predetermined merchant, which use is limited to a predetermined time from which the token is delivered to the consumer.

In yet another implementation, the token requested by a consumer registered with the e-wallet service is a 16 digit number selected by an e-wallet facilitating entity from a pool of available 16-digit numbers. Each 16-digit number in the pool will have been set by an issuer of accounts, such as a bank, a financial institution, etc. Each 16-digit number in the pool, to which the e-wallet facilitating entity has access, can be fully compliant with protocol for account numbers, including mod-10 test complaint, check digit test compliant, etc. Again, the 16-digit token, upon receipt by the requesting consumer, can be manually keyed into the merchant's POS. In the event that such a token is requested by a consumer for use at a particular merchant, but the consumer does not present the token to the particular merchant within a predetermined time frame, then the token's eligibility for use by the consumer will be terminated. The terminated token can then be put back into the pool of available 16-digit tokens by the e-wallet facilitating entity. That token can then be used at another time, upon request, by another consumer who has registered with the e-wallet web service. As such, each 16-digit token is intended to be used by a consumer one time only at a predetermined merchant, which use is limited to a predetermined time from which the token is delivered to the consumer.

Upon confirmation of the consumer's receipt of the requested token, such as by way of an audible and/or visual cue that is rendered by the consumer's cellular telephone or other web enable mobile device, the consumer can then carry merchandise to purchase to a Point Of Service terminal (POS) at the store. Optionally, loyalty and/or promotional type information, including advertisements and targeted offers, can be similarly communicated to the consumer via the cellular telephone for use at the POS.

At the POS, an amount of currency is entered for the purchase. The consumer gives the token to the merchant in any of several ways, such as by allowing the token to be read by the POS from the cellular telephone through a contactless interrogation communication protocol. Optionally, the consumer may also be asked to supply an answer to a security question, such as “What is your Zip Code”, or “What is your “Personal Information Number (PIN) for this transaction”, which answer could be supplied via the consumer's input to a key pad that is in communication with the POS. The POS, which is web enabled, communicates the token, and optionally the consumer's answer(s) to the security question(s), to the e-wallet web service. The e-wallet web service uses the token in conjunction with communications among the e-wallet facilitating entity to determine a corresponding account that had been previously registered with the e-wallet web service and previously selected by the consumer for this transaction with this merchant.

In real time, the e-wallet web service submits a request to authorize the transaction for the amount of currency of the purchase, which transaction is to be conducted on the determined corresponding account. Preferably, although not mandatorily, the request for authorization can be submitted by the e-wallet web service so as to be identical to any other request for authorization. The authorization request can be identical because, upon submission, the account for the transaction will then be known. As is normal in open payment processing systems, via communications through various parties, the authorization of this ‘staged transaction’ for this account is submitted to the issuer of the account. The response to the request for authorization is returned from the issuer, again via communications through various parties, back to the POS. If the transaction on the account is authorized, the consumer can receive the purchase from the merchant and the merchant can receive payment of the amount of the currency for the purchase from the consumer's account through an ordinary clearing and settlement process.

In yet another implementation, an electronic wallet (e-wallet) web based service communicates with a client operated by a consumer to retrieve a list of merchants selling goods and services specified by the consumer. The e-wallet service provides a service engine for the consumer to target desirable merchants. The consumer uses the e-wallet service to see reviews by other consumers who conducted transactions with the merchants on the retrieved list. The consumer select a merchant from the retrieved list. The consumer then selects one or more accounts upon which a staged transaction with the merchant is to be conducted. For each selected account, the e-wallet service issues a one-time-usage-only token that the consumer will use in order to conduct the staged transaction with the selected merchant.

The consumer then conducts the staged transaction with the merchant by the submission of the token(s) to the merchant as form of payment. The consumer uses the token, after conducting the staged transaction with the selected merchant, to gain access to a social media portal. The social media portal allows the consumer to give an opinion about the selected merchant's performance of the staged transaction. Opinions of actual transactions with the merchant can be searched and reviewed by others who will use the e-wallet service when selecting merchants.

In one E-wallet Solution implementation, a consumer can enroll an account corresponding to a payroll deduction account. As such, the consumer enrollment process allows a consumer to add a payroll account as a payment source. In this implementation, there can be a collaboration between an e-wallet facilitating entity and existing payroll vendors (e.g., ADP, Paychex, UltiPro, EasyPay, Ceridian, etc.) This implementation is advantageous to larger employers having 500+ employees who have one or more cafeterias, company stores, etc. An employee can be enrolled for a payroll deduction account in the E-wallet facilitating entity and then use their cellular telephone or other communicating mobile device to obtain a token. The token can then be used to pay for food, goods, services, etc. in a transaction with any participating merchant, included those merchants that are conveniently co-located at the employee's place of employment (e.g., vendors located at the employer's locations, such as a company store, a company cafeteria, etc.) Alternatively, an employee can enroll a payroll deduction account in the E-wallet Solution and then use their cellular telephone, desktop PC, or other communication device to obtain a token that the employee intends to use to make a contribution to a charity through a payroll deduction (e.g., United Way, Combined Federal Campaign, Combined Charities Campaign, etc.)

In use, a consumer accesses an interface menu to make one or more selections. The menu can be, for instance, a pull down menu, selectable radio buttons, etc. The selections can include an account to be used which can be, for instance, a payroll deduction account upon which a token is to be issued. Other selections will provide ‘thresholds’ as to what types of parameters or limits are to be set on the transaction as may be desirable to the user. For instance, the thresholds for use of the token, which can be requested via user selections, can include, but are not limited to: (i) a date and time at which the requested token expires and is no longer useful to conduct a transaction on a selected account; (ii) a maximum currency amount that can be used in a transaction with the token; (iii) the specific or general category of merchant with whom the token can be used to conduct a transaction; (iv) the specific or general category of item(s) that the token can be used to purchase (e.g., those items, for instance, that are eligible for a particular type of tax treatment, such as tax free healthcare related items that would normally be purchased through a company cafeteria plan, Flexible Savings Account (FSA), Healthcare Savings Account (HSA), travel and entertainment related expense items, automotive or vehicle fleet related expense items, etc.)

Once the requested token is delivered to the consumer, such as via an e-mail or text message containing a bar code representation of the token received at the consumer's cellular telephone, the token can be input into a merchant Point of Service terminal (POS) by scanning the bar code as it is rendered on the consumer's cellular telephone display screen. Note also that multiple tokens can be requested for one or more purchases at one or more merchants, where corresponding tokens are encoded into one or more bar codes received by the consumer.

Given the foregoing, in use, the consumer requests a token to be used for a transaction to be conducted at a particular merchant. The consumer also specifies that the consumer's payroll deduction account, or other accounts, are to be used, respectively, to conduct one or more transactions with corresponding merchants. It may be desirable to specify more that one account to be used at the merchant, for instance, if certain items to be purchased from the merchant in the transaction are not eligible to be purchased at the consumer's payroll account or another account that was specified by the consumer. Assuming that predetermined criteria for issuance of the requested token(s) are met for the consumer's request(s), then the consumer will receive delivery of the requested token(s) from the E-wallet Solution.

At the merchant POS, a summation of a currency amount for each item in the consumer's shopping cart is made to calculate a total purchase amount. The calculation may include different tax treatments for each item in the consumer's shopping cart. The consumer's token(s) are submitted at the merchant's POS at ‘check out’. The merchant sends an authorization request message to its acquirer processor, and/or other entity or agent, for a determination as to whether or not the transaction is authorized to proceed. The Acquirer-Processor, or agent thereof, receives the authorization request message from the merchant/POS. The Acquirer-Processor, in one implementation, communicates with one or more E-wallet Facilitating Entity(ies), which may include, but are not limited to, a Transaction Handler Processor (e.g., MasterCard, Discover Card, etc.; the issuer of the account corresponding to the token, etc.). The authorization request message can include the total amount of the transaction that is to be charged to the account corresponding to the token.

In a variation of the foregoing implementation, the authorization request message from the merchant/POS may be responded to by an employer associated with a payroll deduction account corresponding to a token, such as where the employer, or its agent, maintains the consumer's payroll deduction funds so as to guarantee payment to the merchant (e.g.; employer-maintained account(s) containing funds received, or to be received, from employee's payroll deductions for an employer-sponsored plan, such as a Cafeteria Plan, Flexible Saving Plan, Healthcare Savings Plan, etc.) Alternatively, a payroll service may provide an account corresponding to the consumer's token where the payroll service gives a credit line to the consumer's employer to whom payroll services are provided.

In another variation of the foregoing implementation, other data may be sent with the authorization request message. Such other data may include information that identifies items being purchased in the transaction. These data may be used with the authorization process for the requested transaction so as to determine eligibility of each item being purchased on a requested account, such by comparing eligibility account requirements against corresponding identifiers for items being purchased. These item identifiers can be, but are not limited to, the Stock Keeping Unit (SKU), the Universal Product Code (UPC), a Merchant Commodity Code (MCC) for the merchant selling the item, etc. As such, for each token requested by the consumer, there can be a corresponding account that is to be used for items receiving a different tax and/or commodity treatment. Then, the authorization of the transaction can be vetted on an item-by-item basis according to predetermined business rules for authorization of a transaction for the purchase of particular item(s) on the account.

After the transaction is authorized, the merchant/POS can receive a response to the authorization request message for each of the one or more account(s) respectively corresponding to token(s). The transaction can then proceed between the consumer and the merchant. The consumer may thereafter receive a diagnostic confirmation of the transaction with the token(s) (or of a rejection of one or more of the token(s)). Also, clearing and settlement for the transaction on account(s) respectively corresponding to token(s) will take place so that the merchant will be paid for the transaction with the consumer from one or more of the consumer's accounts.

In yet another implementation, rather than requesting a token, an employee can be issued a payment card. This payment card is linked to an account that is tied to a payroll deduction function against the employee's employment pay from the employee's employer. From a financial view point which holds that an employee has already earned some of their pay before pay day, prior to a calendar day on which the employee would normally be paid (i.e.; ‘pay day’), a deposit that is less than the full amount of the employee's employment pay is made into the account corresponding to the payment card. As referred to herein, the payment card is an ‘early partial deposit payroll payment card’. These funds are then available, in advance of the employee's payday, for use by the employee.

The early partial deposit payroll payment card's payroll deduction function enables a secured credit for the employee's transactions with merchants by the employee's use of the early partial deposit payroll payment card. The early partial deposit payroll payment card can be a standard magnetic stripe plastic card, a smart card, or other portable consumer payment device. The payment card can be used at a merchant's Point of Service terminal (POS), thus allowing the employee to pay the merchant using a portion of their payroll as a secured credit type of payment at the POS. Thus, the employee is permitted to spend funds in advance of the employee's pay day, up to a certain amount or a percentage of the employee's total pay (e.g.; ten to fifteen percent).

In essence, through defined partner relationships, there is provided a link to the employee's account for the use of funds well in advance of the payroll payment on the employee's pay day in the employee's bank account. The early partial deposit payroll payment card can be a branded card for a payment processing system (e.g.; VISA, MasterCard, etc.) These early deposited funds can be used in transactions, through prior arrangements, that are not subject to normal and ordinary transaction fees for transactions on the account of the early partial deposit payroll payment card. As such, for an employee using the early partial deposit payroll payment card as a form of payment at a certain merchant's POS, there would be no interchange fees associated with that transaction.

An employee that is unbanked or underbanked, that does not have access to credit or bank accounts, may avoid borrowing from a high interest lender, such as ‘pay day loan’ services. The early partial deposit payroll payment card gives the employee the same ability to pay at a merchant's POS using a card that has an appearance of a typical credit or debt card, though it is not a typical credit or debt card. The account linked to the early partial deposit payroll payment card can be reloaded with each of the employee's reoccurring pay days. As such, the early partial deposit payroll payment card need not be a one-use-only card, but rather can be a reloadable card.

Payroll vendors (e.g., ADP, Paychex, UltiPro, EasyPay, Ceridian, etc.) who provide payroll services to employers can provide related services for the early partial deposit payroll payment card, thus adding to their portfolio of services to the employers in their payroll services provider relationships.

On the employee's pay day, the amount already deposited into the account tied to the early partial deposit payroll payment card would be deducted from the employee's pay and the residual would be made available, less taxes and other deductions, to the employee.

In a variation of the forgoing implementation, the account for the early partial deposit payroll payment card can be registered with the e-wallet solution disclosed herein. Once the account is registered, the employee can stage a transaction with a merchant by requesting a token for use for the merchant, where the token is linked to the account of the early partial deposit payroll payment card. Upon receipt of the requested token, the employee, can then go to the merchant's POS within a predetermined time limit, and present item(s) for purchase along with the token as disclosed elsewhere herein. The token, in one variation, can be a 16-digit number that can be keyed into the POS, where the token is compliant with account number formats and protocols as discussed elsewhere herein.

Upon receipt of the token by the merchant's POS, a real time authorization request can be made against the account corresponding to the token. The authorization request is a query into whether the employee has exceeded funds on deposit in account, or has exceeded a predetermined percentage of the employee's payroll payment to which the employee is given access before the employee's pay day for a particular pay period. This authorization request can be responded to by a payroll vendor (e.g., ADP, Paychex, UltiPro, EasyPay, Ceridian, etc.), or by a payment service provider, to whom data for the employee's transaction with the merchant is sent for review. Upon completing the review, a authorization response can be sent back the merchant. Assuming a favorable authorization response, the merchant can complete the transaction on the account with the employee. Alternatively, instead of a real time authorization, a batch mode authorization can be performed.

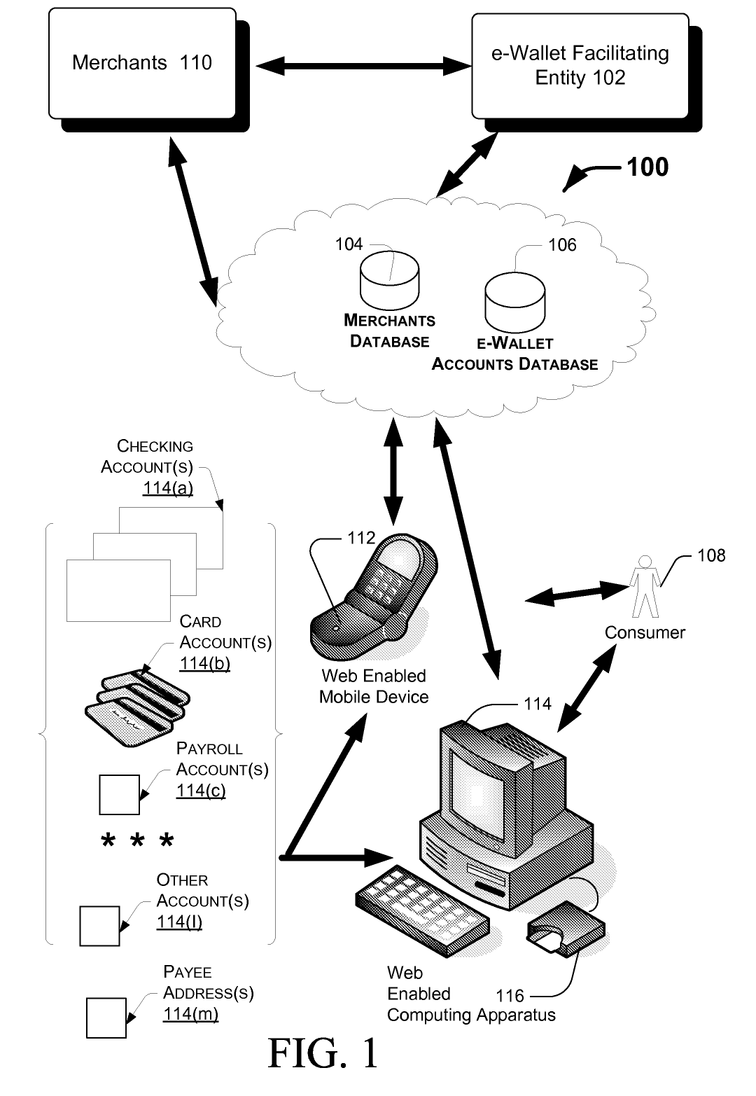

FIG. 1 shows an environment 100 in which a consumer 108 can register accounts issued to the consumer with an e-wallet web service by use of a user interface rendered on a client 112, 114 executing on a web enabled computing apparatus. Each account so registered can correspond to a portable consumer payment device, such as a check book account 114(a) having checks therein that correspond to one of the registered accounts, a card account 114(b), a payroll account of an account holder from which deductions can be made to pay for transactions with merchants, or an account 114(I), where I can be an integer of up to eight (8) digits. By way of example, each registered card account 114(b) can correspond to a credit card, a debit card, a prepaid card, a gift card, a closed loop card that has limited use for transactions with solely one merchant, an open loop card that can be used with a plurality of merchants, a card issued by an issuer in an open system of acquirers and a transaction handler-processor, a card issued by an issuer in a closed system where the issuer is also both the acquirer and the transaction handler/processor, etc. The client 112, 114 may be in communication with a card reader 116 for reading cards to obtain information about the account to be registered with the e-wallet web service.

An e-wallet facilitating entity 102 communicates with client 112, 114 in the registration of the accounts. E-wallet facilitating entity 102 is also in communication with one or more databases, such as are seen at reference numerals 104, 106. Each such database is accessible through a network such as the Internet. Merchants 110 can also be registered with the e-wallet facilitating entity 102, which registration can be stored in a merchants database 104 on one or more network devices. An e-wallet accounts database 106 can be stored on one or more network devices for the storage of registered accounts corresponding to many consumers.

Merchants 110, e-wallet facilitating entity 102, and a plurality of clients 112, 114 communicate with each other through public and private networks, such as through cellular telephony networks, dedicated line networks, and the Internet, for example.

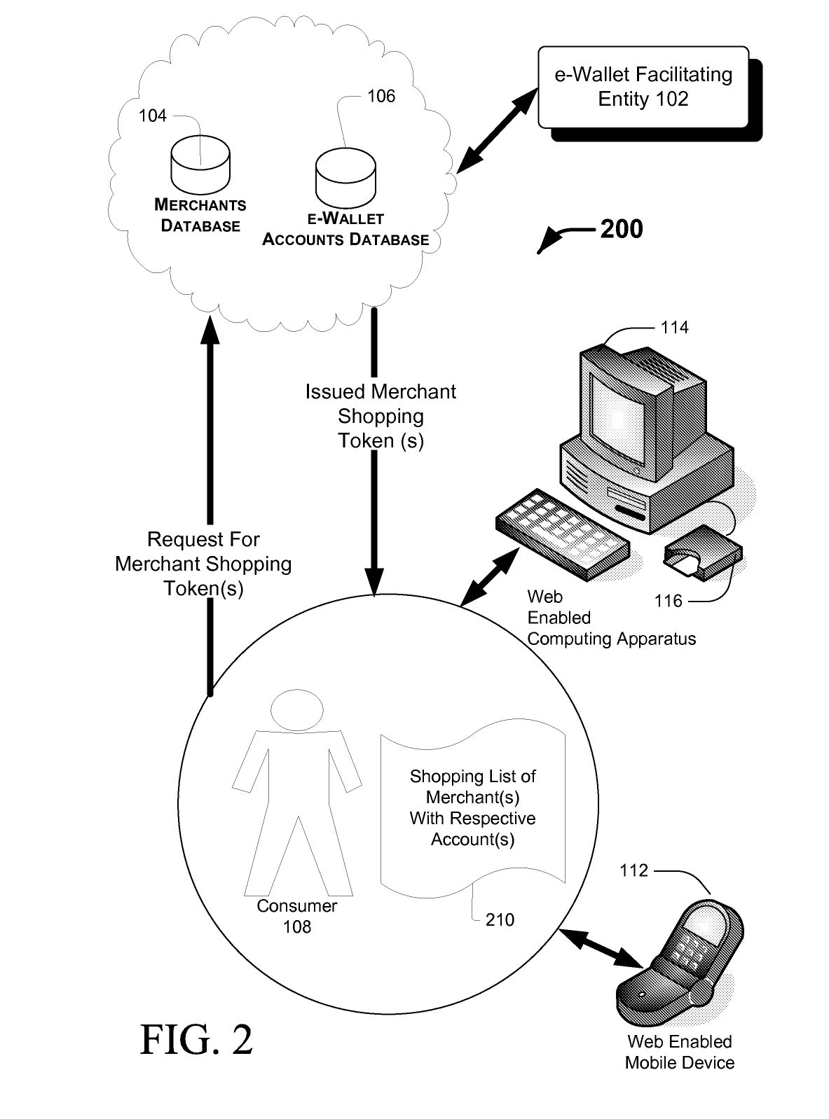

After the consumer 108 registers accounts with the e-wallet facilitating entity 102, FIG. 2 shows an environment 200 in which the consumer 108 uses client 112, 114 to make a request for a token from the e-wallet facilitating entity 102. The token is requested by the consumer 108 to conduct a transaction with a registered merchant 110 that is selected by the consumer 108 by using client 112, 114. Once the consumer 108 receives the requested token, the consumer 108 can conduct the transaction on the consumer's selected registered account. The selected registered account is also selected by the consumer 108 by using of client 112, 114. In one implementation, the consumer 108 can specify the registered account for which a token is to be given by inserting a corresponding card into card reader 116 which is in communication with the client 112, 114 so as to communicate the corresponding account to client 112, 114.

Consumer 108 may have a shopping list 210 of many merchants with whom the consumer 108 wishes to shop. Client 112, 114 is operated by the consumer 108 to locate each of the merchants on the shopping list 210 that have been previously registered with e-wallet facilitating entity 102.

If any such merchant is not so registered, a token cannot be given to the consumer 108. In such cases, however, the e-wallet facilitating entity 102 may generate a message to be sent to the unregistered merchant to ‘sell’ the concept of participating in the e-wallet service. The basis for such a ‘sale’ would be that there have been one or more such unresolved requests for registration by one or more consumers 108. As such, the messages help the e-wallet facilitating entity 102 to promote its services with unregistered merchants whose merchandise is popular with its registered consumers.

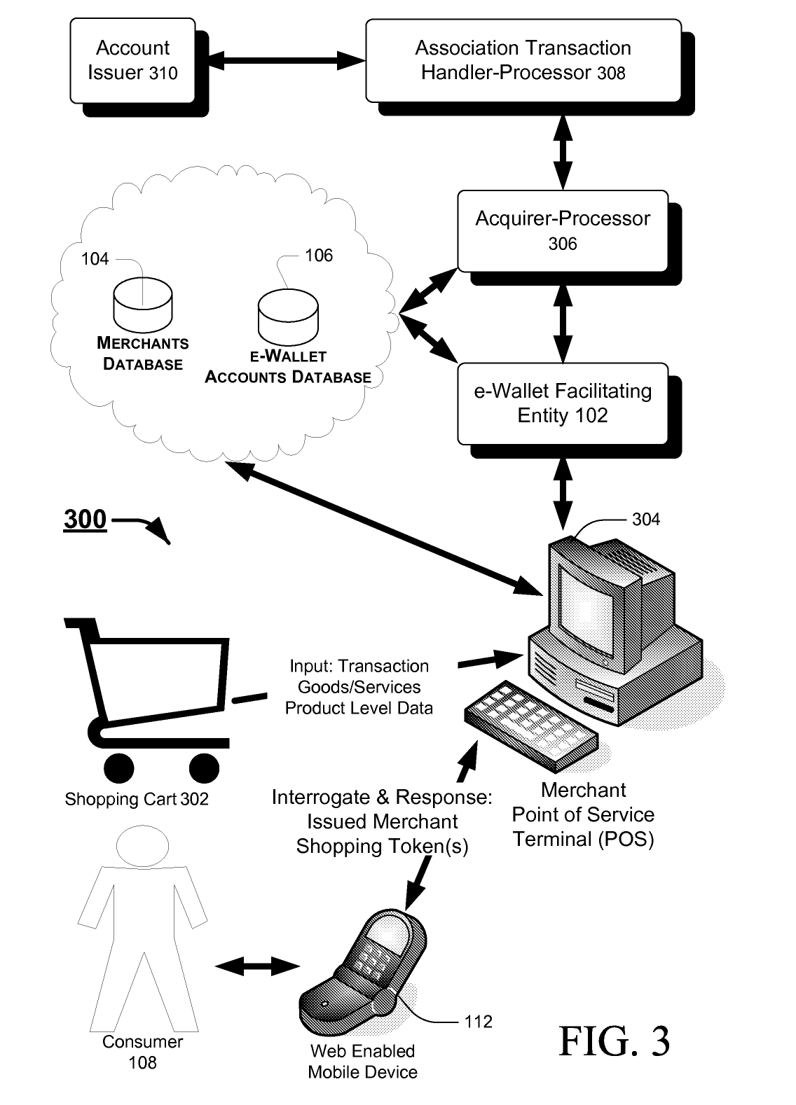

After consumer 108 has registered accounts and requested tokens for merchants 110 on shopping list 210, the consumer 108 can take the tokens and go shopping with the corresponding merchants 110 as seen in an environment 300 of FIG. 3. Each token given to consumer 108 by e-wallet facilitating entity 102 may expire after a predetermined time, which means that if the consumer 108 does not use the token in a timely fashion, the token will no longer be valid to use in a contemplated future transaction with the merchant 110 that has been selected by the consumer 108.

At merchant 110, consumer 108 places merchandise 110 in a shopping cart 302. Shopping cart 302 is then taken to a Point Of Service terminal (POS) 304 where each item of merchandise in shopping cart 302 is summed to a total currency amount. The POS may also collect data as to whether each item will have special tax treatment (e.g., tax free healthcare related items) as well as a corresponding identifier for the item (Universal Product Code, Stock Keeping Unit, Serial Number, etc.) As a form of payment of the total currency amount for the merchandise, consumer 108 offers to merchant 110 the corresponding token(s) received from e-wallet facilitating entity 102.

POS 304 can receive the corresponding token(s) from consumer 108 by the consumer 108 operating web enabled mobile device 112 in which the token(s) is/are stored. In such case, POS 304 interrogates web enabled mobile device 112 to receive the corresponding token(s). The interrogation can be contactless so as to be conducted in any known wireless communication protocol (e.g., Bluetooth, WiFi, Near Field Communication (NFC)). Also, the token(s) can be rendered on a display screen of web enabled mobile device 112 so as to be read into the POS 304, such as where the token(s) is/are rendered as a bar code or other object that can be scanned by a bar code scanning reader apparatus that is in communication with POS 304. Alternatively, and/or in combination, a voice mail message containing an alphanumeric or numeric rendering of the token can be audibly rendered by web enabled mobile device 112 so as to be heard by an operator of POS 304 who then ‘keys in’ the audibly rendered token. Alternatively, a voice recognition device in communication with POS 304 can ‘listen to’ the audible rendering and thereby input the token into POS 304. Of course, consumer 108 can simply tell the cashier what the token is so that the cashier can input the token manually into the POS 304.

Upon receipt of the token by POS 304, the token is communicated to e-wallet facilitating entity 102 for a determination of the corresponding registered account upon which the transaction with merchant 110 is to be conducted. Normal authorization of the determined registered account for the contemplated transaction then proceeds as with any other cashless transaction conducted on an account issued by a bank or an issuer to a consumer. In a normal authorization, network communications occur between an issuer 310 of the account, an association transaction handler-processor 308 (e.g., Master Card, Discover Card, Visa, Diners Club, American Express, etc.), the e-wallet facilitating entity 102, and the POS 304 at merchant 110 (not shown in FIG. 3). When authorization of the transaction is received by the POS 304 from the account issuer 310, either alone or with another entity responsible at least in part for responding to authorization requests, the transaction can be completed for further clearing and settlement.

The token presented to POS 304 at a pre-selected merchant normally can be used by the e-wallet facilitating service 102 to determine the corresponding registered account. The token may also, but need not, contain information that can be correlated with data other than the corresponding account that is registered with the e-wallet facilitating entity 102. For instance, in some implementations, the token correlates to a specific selected location of the merchant 110 and/or the POS 304. In still other implementations, the token can be used to determine the item(s) that are to be purchased in a contemplated future transaction, categories or commodities of item(s) that can be purchased in a contemplated future transaction with the corresponding selected merchant, a particular manufacturer corresponding to an item to be purchased in a contemplated future transaction, a particular time frame in which a contemplated future transaction is to take place, a maximum amount of currency permitted for the contemplated future transaction with the selected merchant, etc.

In another implementation, one or more Payee Addresses 114(m) as shown in FIG. 1, can be registered by consumer 108 with the e-wallet web service. Once the payee addresses 114(m) have been registered, a registered address can be selected by the consumer 108 using a user interface rendered on a client 112, 114. Such selection, along with other selections described herein, will direct that a token be sent, as described herein, to the selected address (e.g.; an e-mail sent to an e-mail address, a voice message and/or text message sent to cellular telephone number, a facsimile sent to facsimile number, a letter sent to a street address). Upon receipt of the token by the payee at the selected address, the payee can use the token to conduct a staged transaction, within a predetermined time, with a merchant that was also selected by the consumer as described herein. As such, the consumer 108 can direct gifts, payments, and other funds to a selected payee by way of delivery of a consumer-requested token to the payee address as was selected by the consumer by the consumer's interactive use of client 112, 114. For example, consumer 108 may select a specific merchant such as the U.S. Postal Service, a maximum transaction amount of twenty dollars ($20 US), a payee address of “1234678@aol.com”. The requested token will then be delivered to that e-mail address. The payee gets the token via e-mail, goes to a U.S. Postal Service location within a predetermined time from of the token being sent to the e-mail address, and gives the token to a Postal Service agent to buy eight dollars ($8 US) in postage stamps. As the token can only be used once at one merchant for a predetermined time, the remainder of the maximum amount of the twenty dollars ($20 US) cannot be used by the payee. Also, the payee may only us the token at the U.S. Postal Service as opposed to other merchants.

In a variation of the forgoing implementation, the token sent to the payee address may be a 16-digit token for which the digits are compatible with typical account number protocol, as discussed elsewhere herein. The 16-digit token can be compliant with mod-10 checks, and check digit tests. The payee, upon receipt of the token, can give the token to a merchant's POS to manually key into the POS, thereby representing a payment for a purchase. The merchant's acquirer, or agent thereof, can process the token to derive an account upon which the transaction for the purchase is to be conducted as described elsewhere herein.

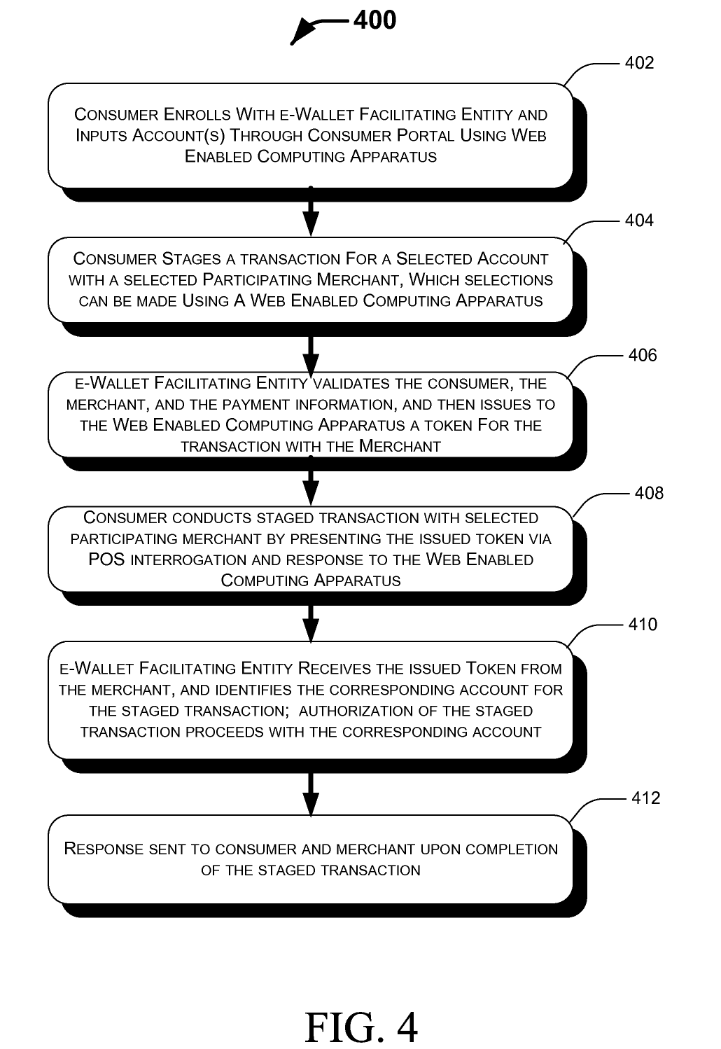

Environment 100, 200 and 300, for FIGS. 1-3, respectively, are suitable for performing a method 400 seen in FIG. 4. At step 402 of method 4, a consumer enrolls with an e-wallet facilitating entity and inputs account(s) through a consumer portal using a web enabled computing apparatus. At step 404, the consumer stages a contemplated future transaction for a selected registered account with a selected participating merchant, which selections can be made using a web enabled mobile device. At step 406 of method 400, the e-wallet facilitating entity validates the consumer, the merchant, and the payment information, and then issues to the web enabled mobile computing apparatus a token for the contemplated future transaction for the selected registered account with the selected participating merchant. The token, in some implementations, is valid for use only within a predetermined time frame. At step 408 of method 400, the consumer conducts the staged transaction with the selected participating merchant by presenting the web enabled mobile device for interrogation and response to a POS for the reading there from of the corresponding token which is stored in the web enabled mobile device.

In some implementations, the consumer can stage the transaction just before the transaction is conducted. For instance, the consumer may already be in the merchant's store. The consumer may be in a situation of not having a wallet, a purse, a credit card, a check book, an identification card, or cash. In such a case, while the consumer is in the merchant's store, the consumer can operate the web enabled mobile device to access the World Wide Web, browse to a web site at which the token can be requested for the merchant, and then receive the requested token for storage in the web enabled mobile device. Step 408 then proceeds as described above.

At step 410, the e-wallet facilitating entity receives the token from the POS and/or the merchant, identifies the corresponding account for the staged transaction (and any other information that can be determined from the token), and then normal authorization of the staged transaction proceeds with the corresponding registered account. Assuming that the transaction is authorized, at step 412, a response is sent to the consumer (such as via the web enabled mobile device) and to the selected merchant upon completion of the staged transaction.

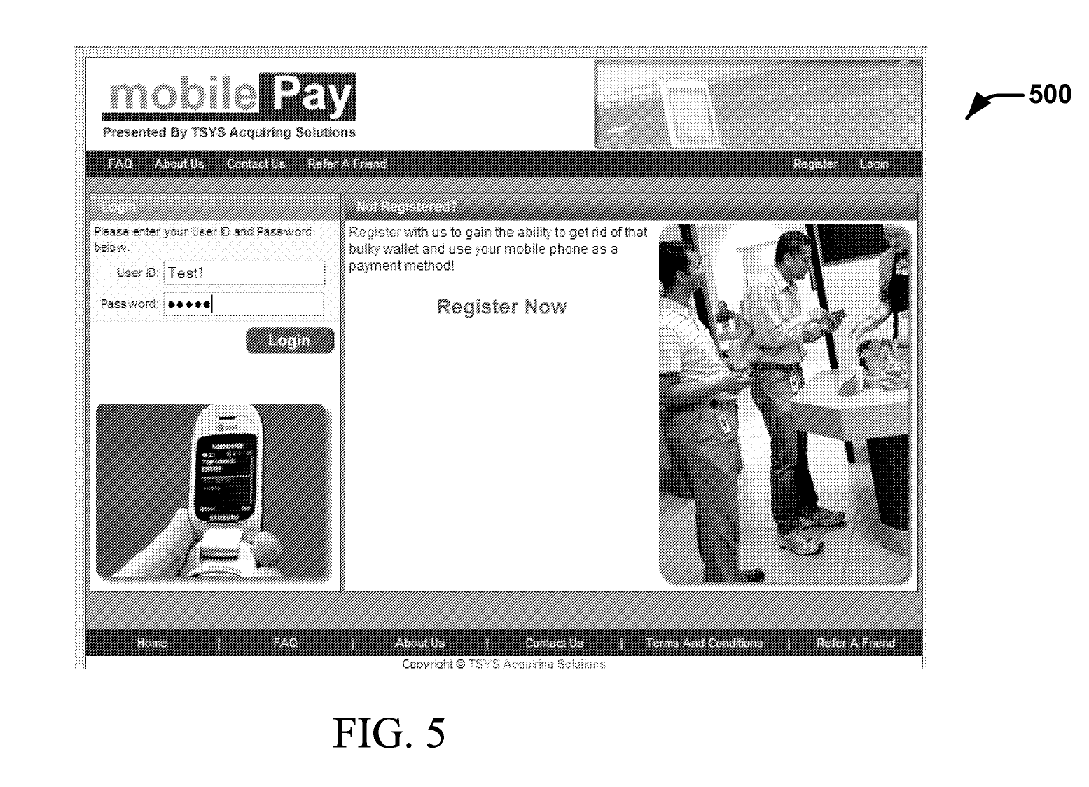

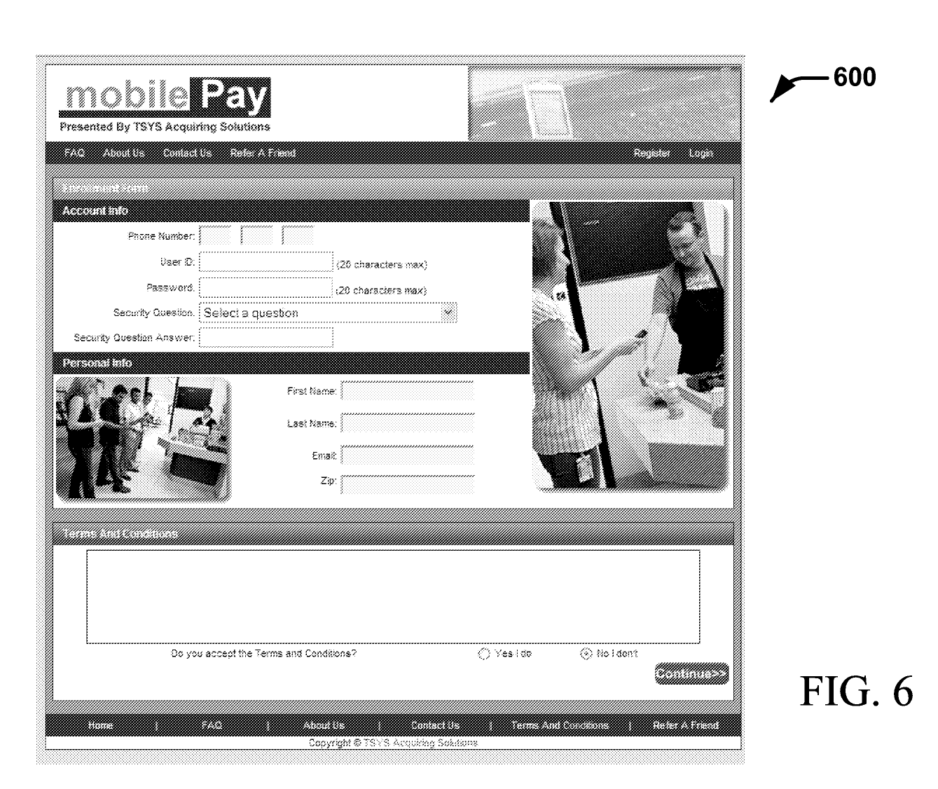

Referring now to FIGS. 5-10, and also to FIGS. 1-3, screen shots 500-1000, depict a user experience of registering accounts with the e-wallet facilitating entity 102. Each account so registered was issued to the consumer 108 by one or more banks or issuers 310. Screen shot 500 shows the user interface for a registered consumer logging into the e-wallet web service. For first time users not yet registered with the e-wallet web service, the user experience is illustrated by screen shots 500-600.

Screen shot 700 shows, for the depicted registered user, a screen area to list the last five (5) staged transactions, and another screen area to list the last five (5) completed transactions that had been previously staged. Also shown are a link to obtain an account summary for the registered user, a user administration link, a link to add accounts, and a link to find merchants participating in the e-wallet web service.

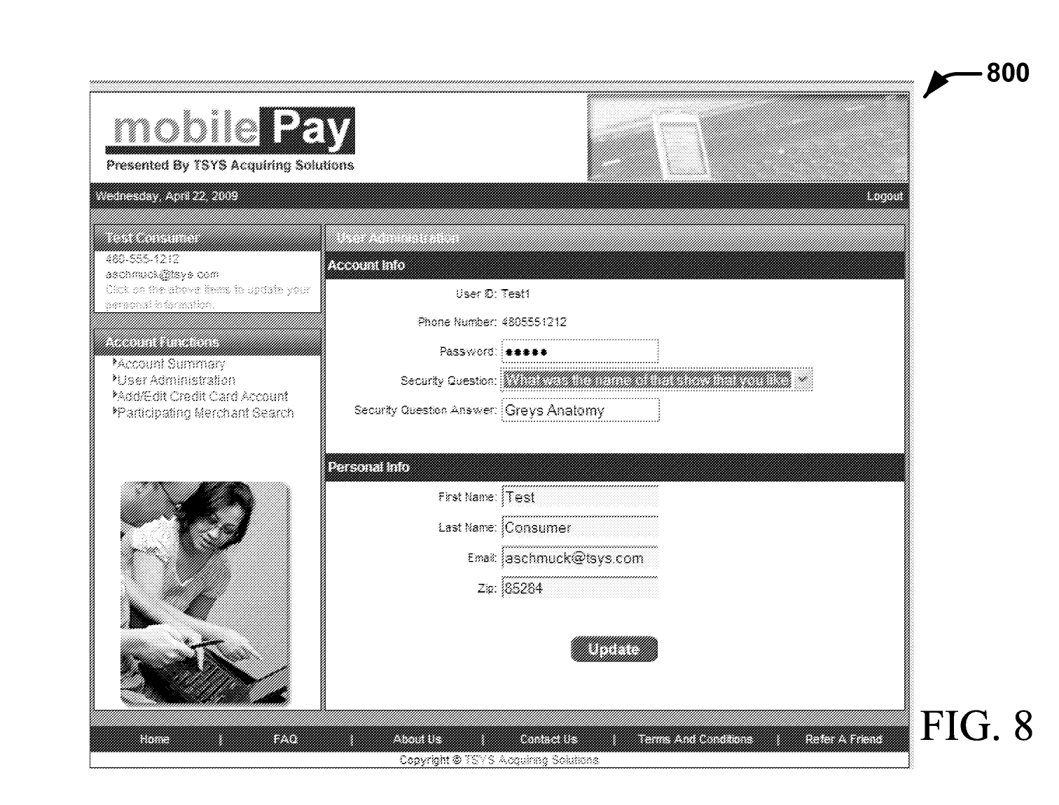

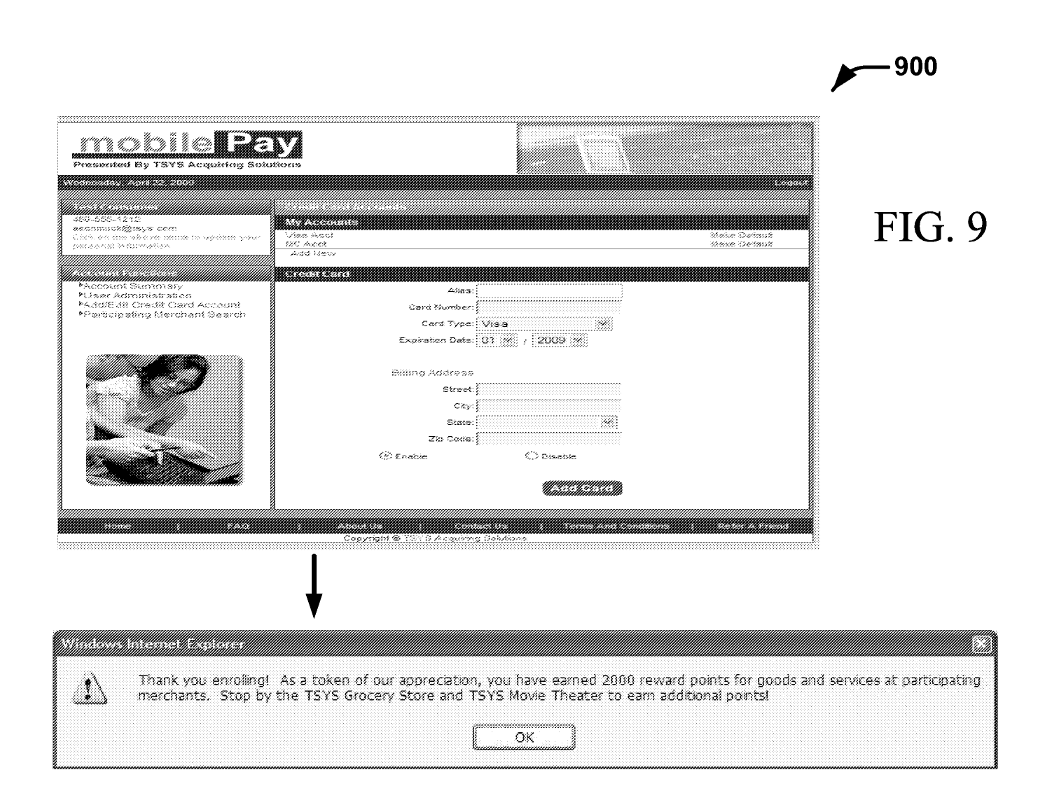

By following the user administration link in screen shot 700, the user will navigate to the screen shot 800 in FIG. 8 at which user information can be input, edited, and deleted. By following the link to add accounts in screen shot 700, the user will navigate to the screen shot 900 in FIG. 9 at which information about an account of the consumer to which the account was issued can be input, edited, and deleted. After a user enrolls a first account in the e-wallet web service, optionally, a reward can be given as indicated by the diagnostic displayed at the bottom of screen shot 900. The giving of the reward may be by way of a deposit of a predetermined amount of a loyalty reward currency to a loyalty reward account belonging to the consumer.

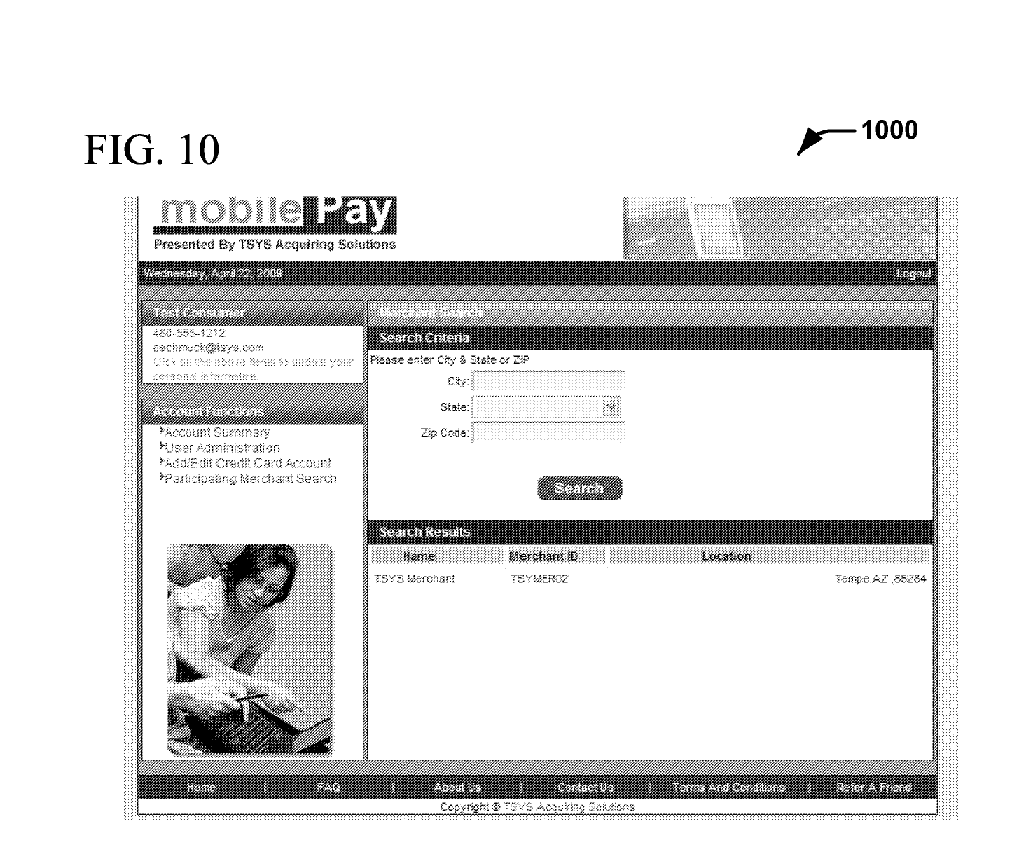

By following the link to find merchants participating in the e-wallet web service in screen shot 700, the user will navigate to the screen shot 1000 in FIG. 10. In screen shot 1000, an area of the screen shows a merchant “TSYS Merchant” having Merchant ID “TYSMER02” that is located in Tempe, Ariz. 85284 who is participating in the e-wallet web service and with whom the user can stage a contemplated future transaction. Again, the participating merchant, by prior agreement, will accept a token from the registered consumer to request authorization for the transaction using the token that had been given to the consumer by the e-wallet web service and corresponds to one of the consumer's registered account.

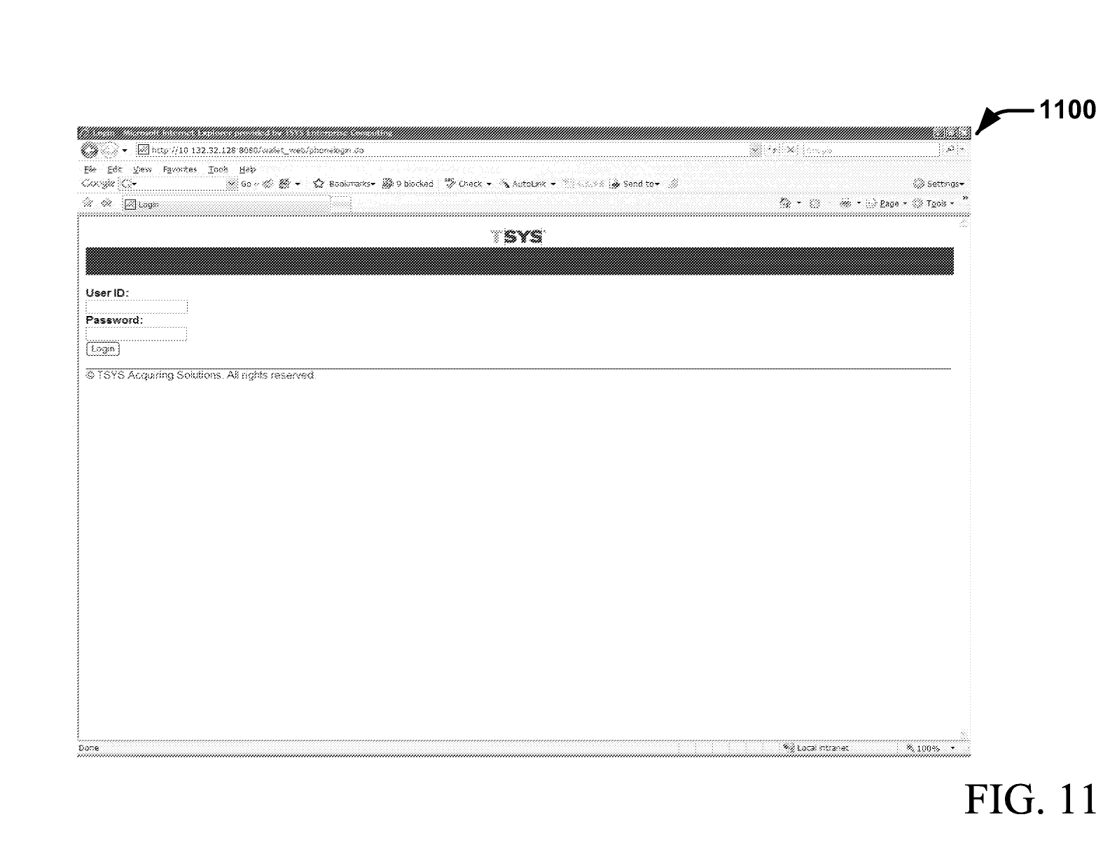

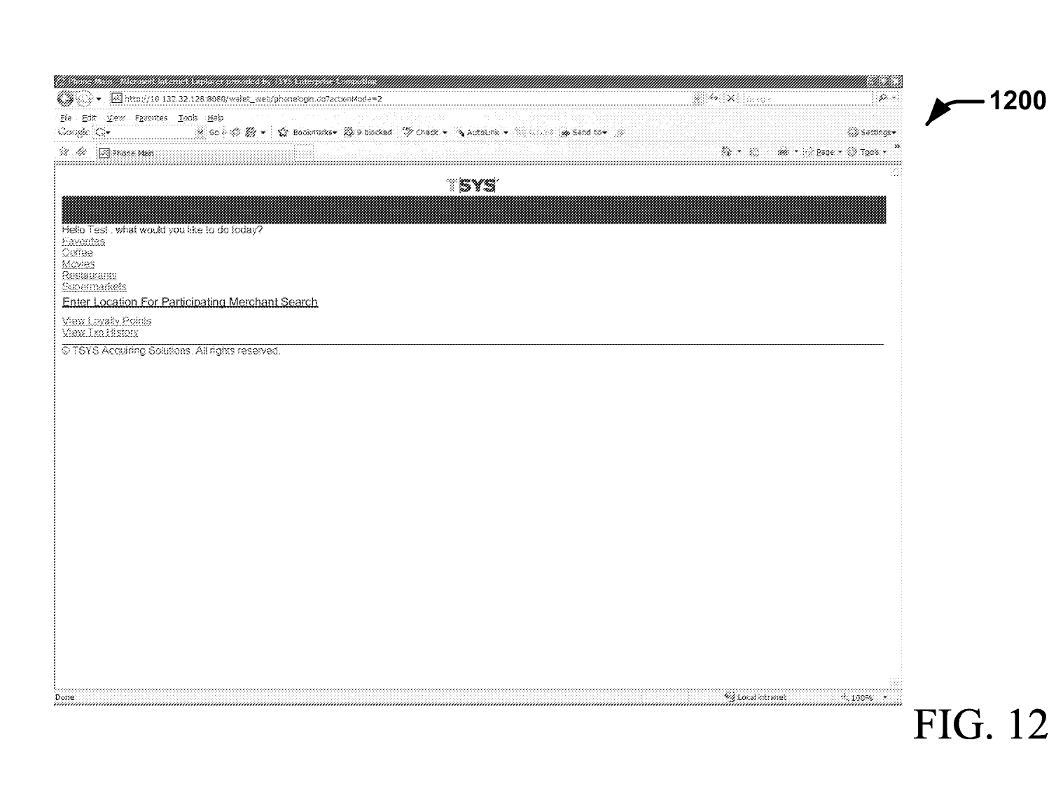

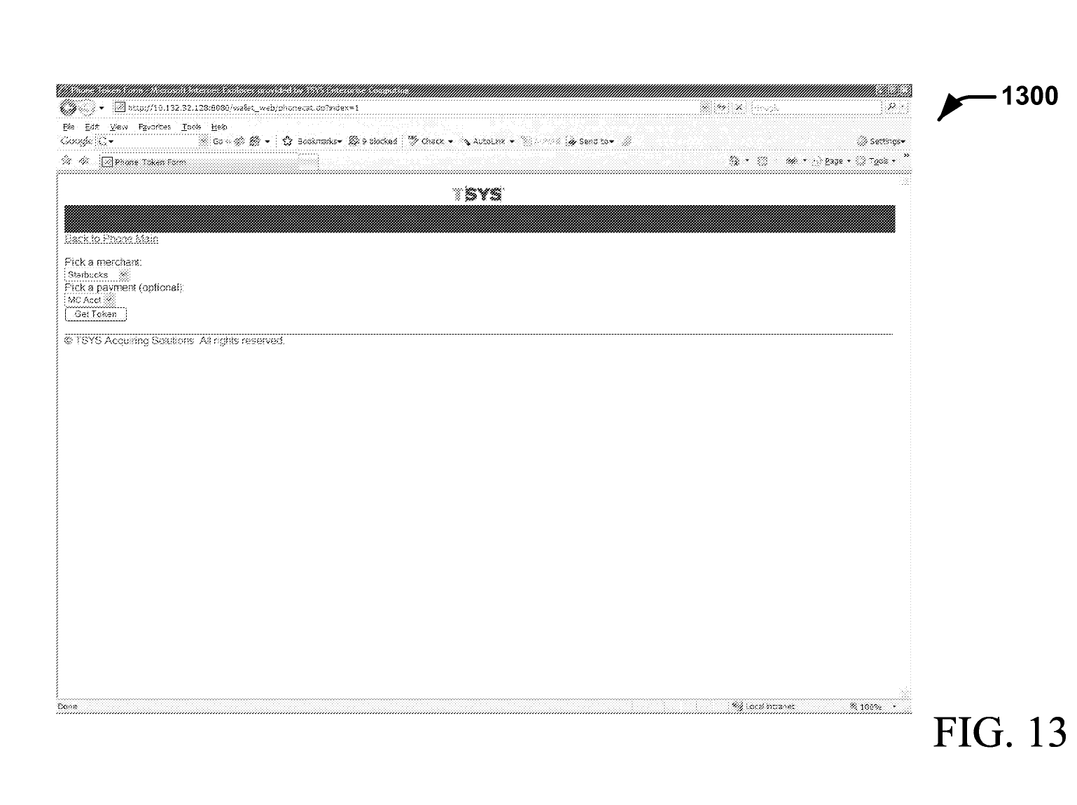

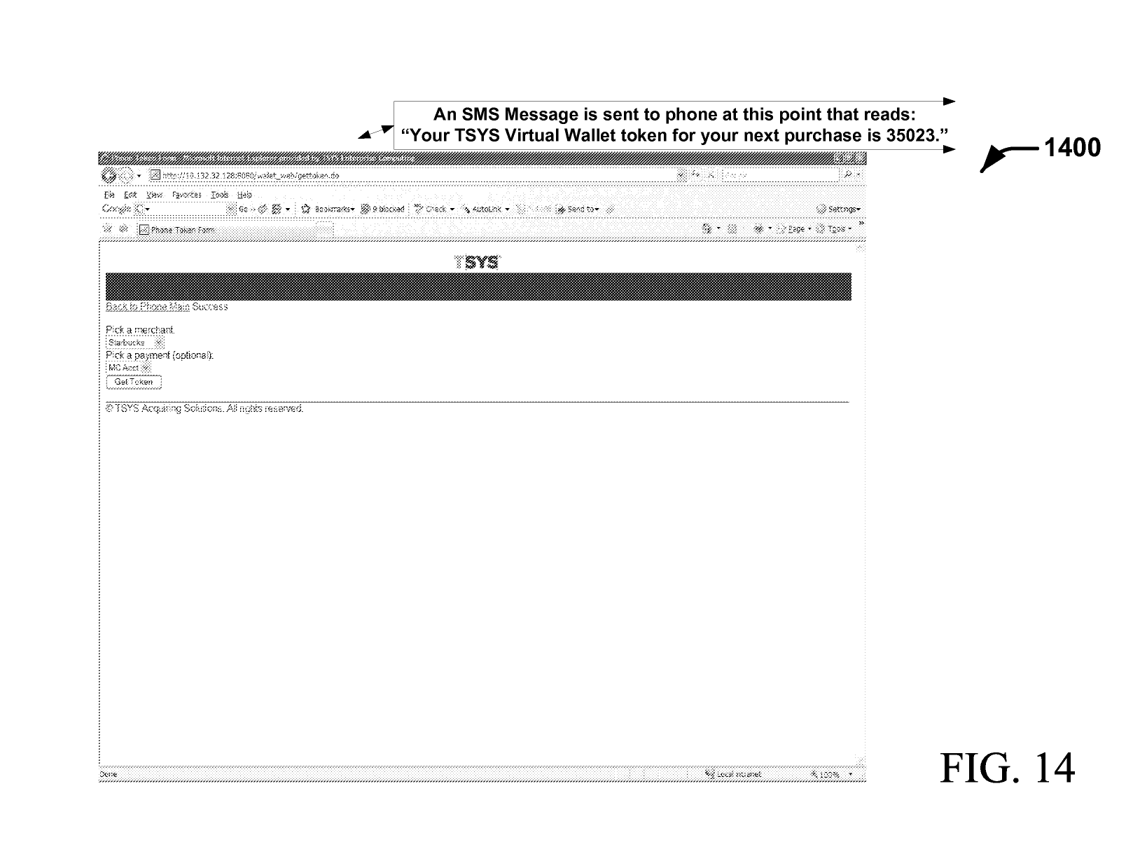

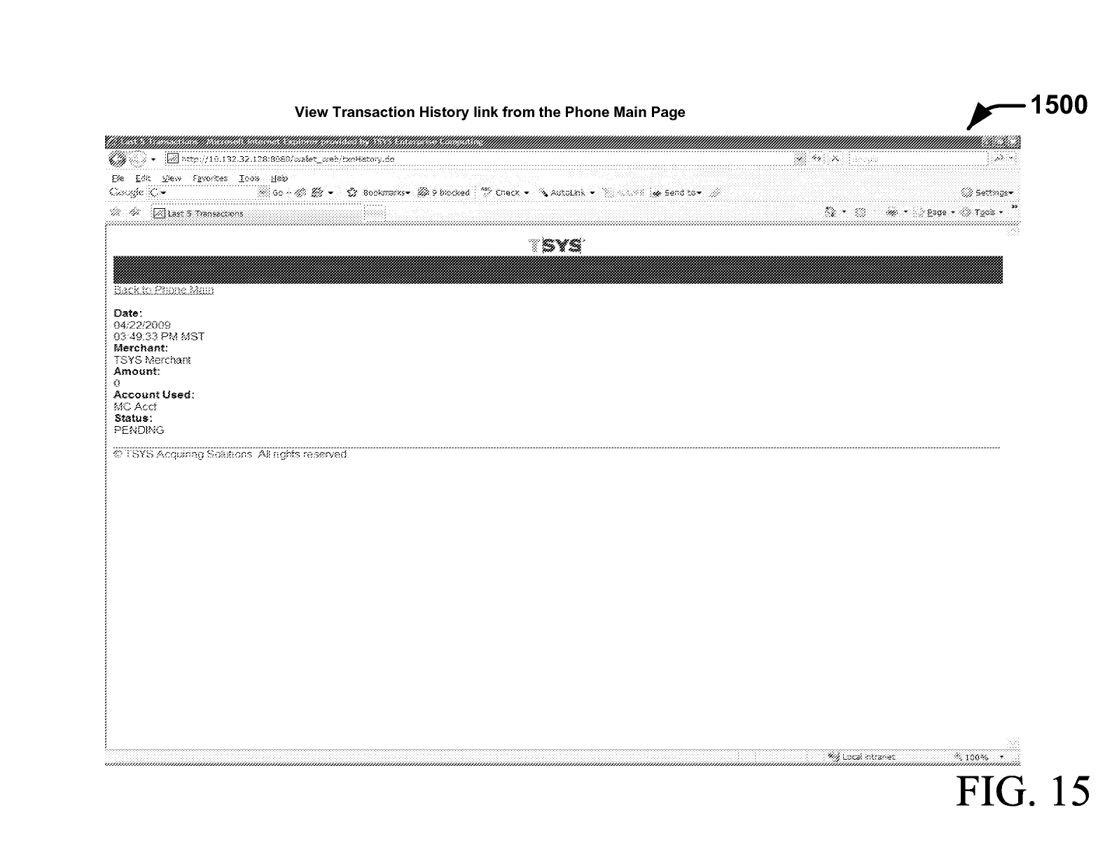

Referring now to FIGS. 11-15, and also to FIG. 2, screen shots 1100-1500, depict a user experience of logging into an e-wallet web service (screen shot 1100), locating merchants or categories of merchants (favorite categories, coffee, movies, restaurants, supermarkets, and/or a location to search) participating in the e-wallet web service as well as navigation links for viewing past transaction historical data (“View Txn History”) and loyalty currency balance(s) (screen shot 1200), and requesting and receiving tokens corresponding to registered accounts and further corresponding to merchants registered with the e-wallet web service with whom the consumer wishes to conduct cashless transactions (screen shots 1300, 1400 and 1500).

In screen shot 1300, the selected participating merchant shown is “Starbucks”, the selected account rendered in a pull down menu is “MC Acct”, and the requested action on the user interface is “Get Token”. The pull down menu may have a variety of menu selections, each of which is a ‘nick name’ or short hand reference to a particular account that the consumer has previously registered with the e-wallet service. Examples of such nick names that may be listed upon activation of the pull down menu are as follows: “Pay Roll Deduction Account”; “Flexible Saving Account (FSA)”, “Health Savings Account (HSA)”; “Work Cafeteria Plan Acct.”; “Bob's checking account”; “Mary's Green Dot prepaid card”; “Sue's Barnes & Nobles gift card”; “My Starbucks Christmas Gift Card From Mom”; “1st Visa Debit Card”; “Dad's credit card”; “Fleet Card@Work”; “Chase Manhattan Southwest Airlines Visa Concierge Acct.”; “Gharry's Big and Tall Shops”; “The Boss's Diners Club”; “AMX1”; “Discover23”; “CTO/CIO T&E card”; “Saving Acct—Emergencies Only!”, etc.

The “Get Token” link on screen shot 1400 may initiate a token request. The token request may be vetted in several ways by several different parties, or the vetting process can be quite simple and limited in the number of collaborating entities. For instance, the identification of the client operating on the mobile device that is making the request for the token may need to be communicated for validation against one or more access control databases. This identification can be, for instance, by way of a “CALLER ID” function that communicates the telephone number or logical address of the mobile device. Other data may also be needed to be input by the consumer and communicated for comparison against the one or more access control databases. Collaborating entities for the validation and creation of the requested token may be limited to just the e-wallet facilitating entity, but may also include the acquirer-processor.

Navigation upon selection of the “Get Token” link is to screen shot 1400 which renders the diagnostic “Success”, meaning that the requested token had been given and stored on a ‘e-wallet device’, such as the consumer's cellular telephone or other mobile computing device. Similarly, screen shot 1500 shows a status of “PENDING” for a token requested for the “MCC Acct” for an amount “0” for participating merchant “TSYS Merchant” as of the date and time indicated.

In an alternative implementation, the consumer may already be located in a store of a merchant and has already made a selection of one or more items to purchase. The store's location can be determined through a geo-locating function of the consumer's cellular telephone or other web enabled mobile computing apparatus. The consumer would then operate their mobile apparatus to contact the e-wallet web service and communicate their location to ‘look up’ the store of the merchant corresponding to the geo-location of the merchant. If the ‘look up’ request to the e-wallet web service returns a response that the location matches that of a participating merchant, the token can then be requested from the e-wallet facilitating entity. When the requested token is delivered to the consumer's mobile apparatus, the consumer can go to a POS to ‘check out’ and make the desired purchase of the previously selected one or more items. As such, the transaction has been completed with the merchant without requiring the consumer to have actual knowledge or notice as to the name or location of the merchant with whom the transaction was conducted.

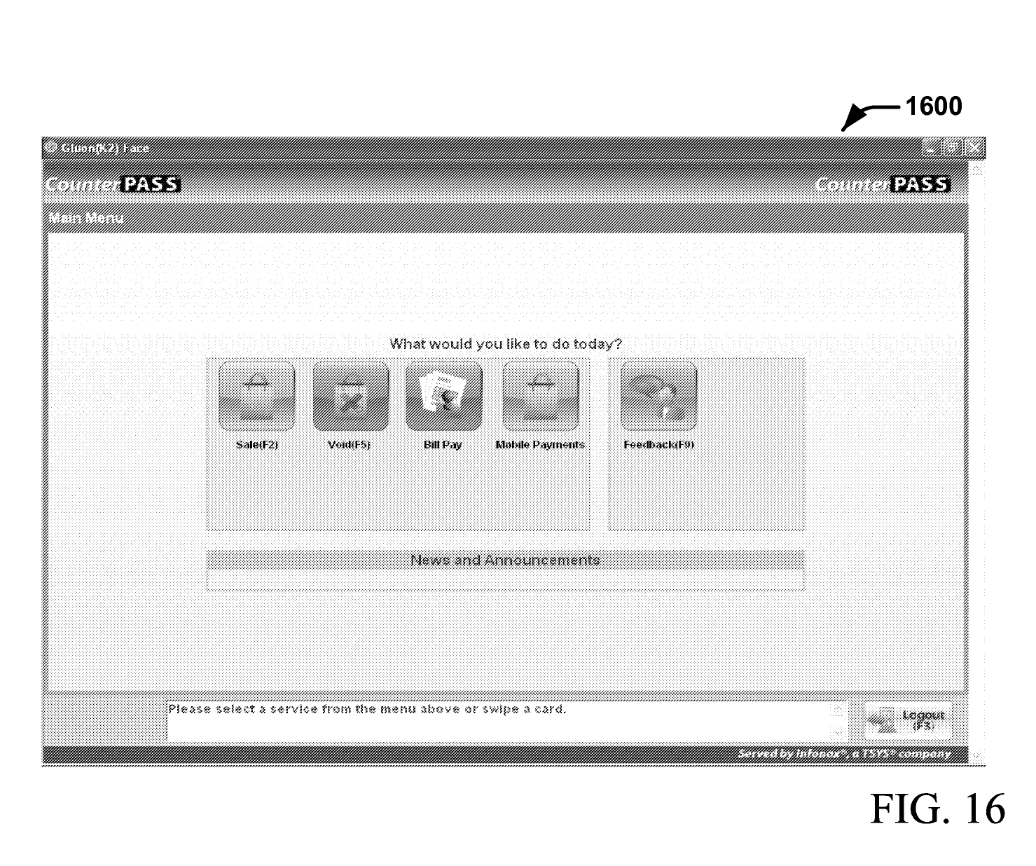

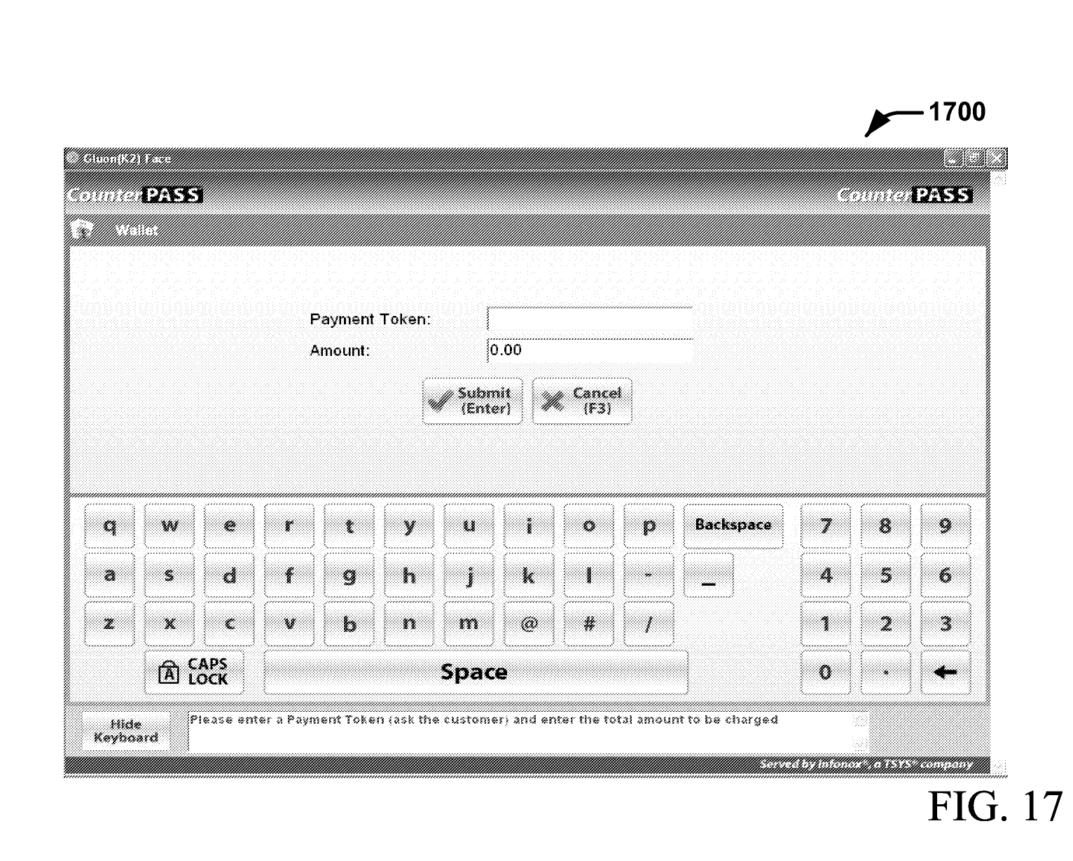

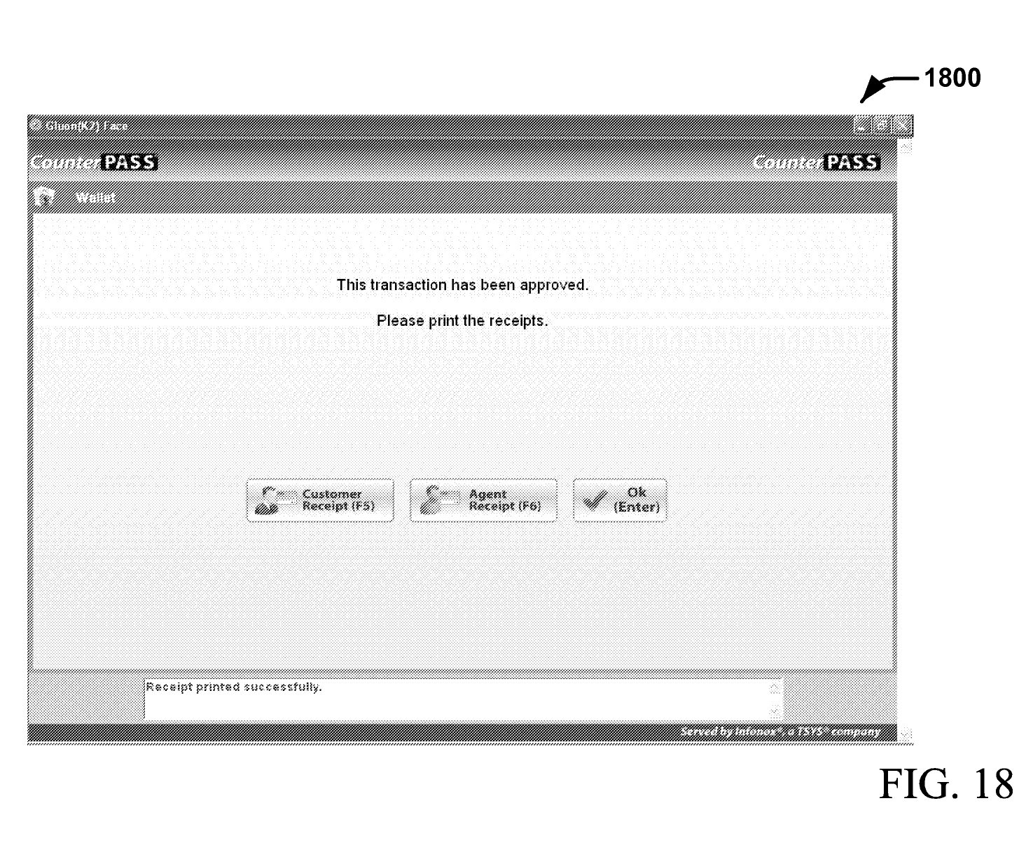

Referring now to FIGS. 16-18, and also to FIG. 3, screen shots 1600-1800, depict a user experience of an operator of a merchant's POS 304. FIG. 16 shows a screen shot that features a navigation link rendered as “Mobile Payments”. Selection of this link navigates to screen shot 1700 where the token is entered. The entering of the token shown in screen shot 1700 is depicted as being by manual operator input to a virtual keyboard rendered on a touch sensitive screen of POS 304. Alternatively, the token can be acquired by contactless communication (e.g., Near Field Communications (NFC), Bluetooth, Wi-Fi, IrDA, etc.) between the POS 304 and the consumer's cellular telephone. The payload of the contactless communication includes the token retrieved upon interrogation of data storage in the cellular telephone. Of course, other ways of communicating the token to the POS 304 are also contemplated. An amount can be entered, as above, in screen shot 1700. The amount is the amount of currency that is to be assessed to the account that corresponds to the token for the staged transaction.

POS 304 communicates the token through access to the e-wallet web service 102, and/or the acquirer-processor 306, to determine the corresponding account that had been previously registered with the e-wallet web service 102. The e-wallet web service 102 submits a request to authorize a transaction for an amount of currency of the transaction, which transaction is to be conducted on the determined corresponding account. As is the normal case in open payment processing systems, the authorization of this staged transaction for this account is through the issuer 310 of the account. The response to the request for authorization is returned to the POS 304. If the staged transaction on the account for the amount is authorized, then screen shot 1800 is rendered to show the diagnostic “This transaction has been approved. Please print the receipts.” The consumer 108 can then receive the purchased items of the transaction from the merchant who in turn can receive payment of the amount of the currency for the transaction from the consumer 108's account through an ordinary clearing and settlement process.

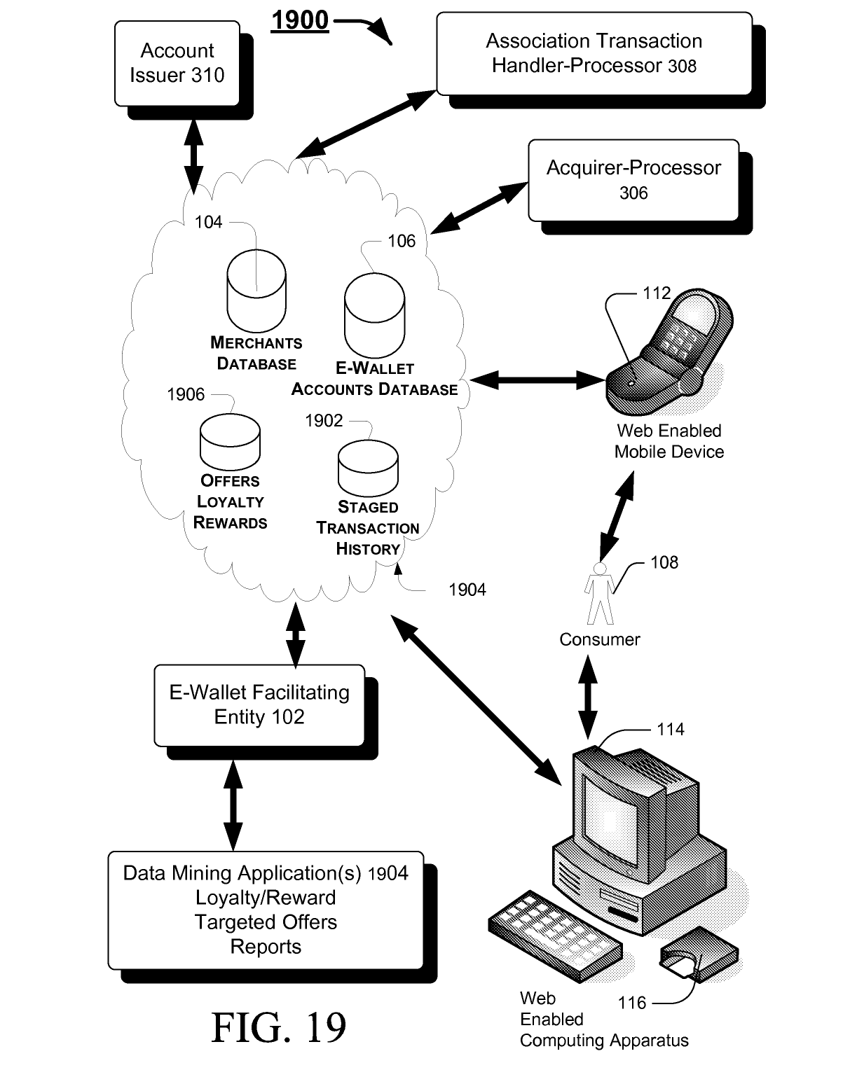

FIG. 19 shows an environment 1900 in which e-wallet facilitating entity 102 can perform data mining. Data can be mined from storage 1904 on a network that includes one or more databases 104, 106, 1902, 1906. One or more databases 1902, for instance, store historical data from past staged complete and/or incomplete transactions with registered merchants conducted by registered consumers on registered accounts. Alternatively, data can be mined from databases 1902 for requests from registered consumers made to unregistered merchants. Each such request that is stored corresponds to a request from a registered customer that an unregistered merchant become registered so that the registered consumer can use the e-wallet service with the merchant.

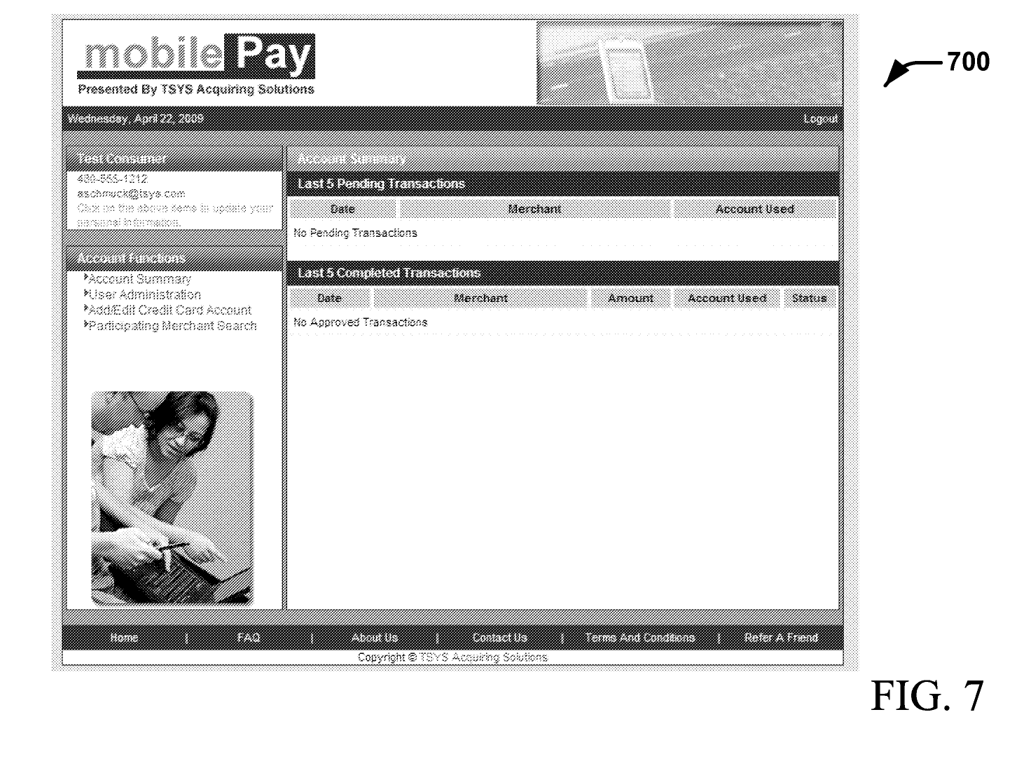

Merchants database 104 can store not only the name of the entity being registered with the e-wallet web service, but also the physical location of each such merchant, as well as any offers, rewards, incentives, coupons, discounts, rebates, and/or special financing that the registered merchant is willing to make to registered consumers through the e-wallet web service. For each stored staged transaction in the database 1902, there can also be in include the location of a consumer's web enabled mobile device as may have been determined, such as through: (i) a cellular telephone network; (ii) through a global satellite position (GPS) functionality of the consumer's web enabled mobile device; (iv) through identifying local wireless local area networks proximal the consumer's web enabled mobile device and cross referencing those that are identified against a database of know geographic locations of wireless local area networks; (v) through a combination of the foregoing, (vi) etc. This position is communicated to e-wallet facilitating entity 102. The e-wallet facilitating entity 102 matches the received location of the consumer with one of the registered merchant's locations in merchant database 104 that is co-located within a predetermined proximity of the consumer's web enabled mobile device. Upon finding a match, an offer can determined from one or more offer/loyalty/reward databases 1906 via a targeted offer application 1904 which may also use databases 104, 106, and/or 2002 by e-wallet facilitating entity 102. The determined target offer(s) can then be sent to the consumer 108's web enabled mobile device 112 so as to include, or not include, a token to conduct a staged transaction at the matching location with the matching merchant. The consumer may extend and/or limit receptiveness to such offers, as well as privacy parameters, by way of setting the consumer's preferences through a user interface to the e-wallet web service, such as via the “User Administration” function seen in screen shot 700 of FIG. 7.

E-wallet facilitating entity 102 can execute data mining application 1904 to create reports as to the success of loyalty and reward programs, targeted offer programs, etc. As the reports can be operated as a revenue producing source, the data mined through operation of the e-wallet web service over time will permit other revenue sources, both individual to the e-wallet facilitating entity 102, as well as through collaborations with issuers 310, association transaction handlers-processors 308, acquirer-processors 306 merchants 110, and consumers 108.

In one implementation, given here by way of example and not by way of limitation, a consumer can enter a convenience store carrying only a cellular telephone, select a beverage to purchase and consume, access the e-wallet web service through a browser application executing on the cellular telephone to communicate with a corresponding cellular network to the World Wide Web, browse on the browser application to locate the convenience store as a participating merchant in the e-wallet web service, and request a token for the convenience store using the user interface rendered on the cellular telephone.

In requesting the token, the user may be provided with a user interface rendered on the browser that allows the user to make several different selections with the request for the token. These selections include a selection of an account upon which the transaction is to be conduct, a maximum time limit to conduct the transaction before the token expires and can no longer can be used, a maximum currency amount that is permissible for the transaction, and other customizable selections. Each such selection can be offered to the user in a conventional manner, such as pull-down menus, radio buttons, pre-populated data field, etc.

By way of example of the user's selections, the selection of the account upon which the transaction is to be conducted can be made by a selection from a list of accounts that is represented on the user interface as follows: “Pay Roll Deduction Account”; “Flexible Saving Account (FSA)”, “Health Savings Account (HSA)”; “Work Cafeteria Plan Acct.”; “Bob's checking account”; “Mary's Green Dot prepaid card”; “Sue's Barnes & Nobles gift card”; “My Starbucks Christmas Gift Card From Mom”; “1st Visa Debit Card”; “Dad's credit card”; “Fleet Card@Work”; “Chase Manhattan Southwest Airlines Visa Concierge Acct.”; “Gharry's Big and Tall Shops”; “The Boss's Diners Club”; “AMX1”; “Discover23”; “CTO/CIO T&E card”; “Saving Acct—Emergencies Only!”, etc. The user can also set certain thresholds for the token's use. For instance, the user can make a selection of the time limit before the request token no longer can be used (e.g., in increments of ten (10) minutes from the sending of the token (e.g. 10 minutes, 20 minutes, one-half hour, twenty-four hours, etc.)). The user can make a selection of the maximum amount of currency for which the token can be used in a transaction with an identified merchant, for instance, in increments of ten (10) US dollars (e.g. $10 US; $50 US; $200 US; $1000 US).

Of course, the user may not have any selections to make, for instance, if these thresholds for using the requested token are predetermined, either by way of the account issuer's specification, the user's prior specification, an employer's rules regarding merchants from whom purchases can be made by using payroll deductions as the mode of payment for the E-wallet Solution, etc. As such, the user may have limited choices to make when using an implementation of the E-wallet Solution.

Upon confirmation of an audible and/or visual cue rendering on the cellular telephone that the token had been received, the consumer then approaches a POS at the convenience store. An amount of currency is entered for the beverage at the POS and the consumer allows the token to be read by the POS from the cellular telephone in a contactless interrogation. The POS communicates the token through access to the e-wallet web service to determine the corresponding account that had been previously registered with the e-wallet web service for this staged transaction. The e-wallet web service submits a request to authorize a transaction for an amount of currency for the beverage, which transaction is to be conducted on the determined corresponding account. As is the normal case in open payment processing systems, the authorization of this transaction for this account is through the issuer of the account. The response to the request for authorization is returned to the POS. If the transaction on the account is authorized, the consumer can receive the beverage at the convenience store and the merchant can receive payment of the amount of the currency for the beverage from the consumer's account through an ordinary clearing and settlement process.

In another implementation, a consumer operates a web enabled computing apparatus in communication with an e-wallet service to: (i) retrieve a list of merchants selling goods and services specified by the consumer; (ii) study reviews of made consumer who conducted transactions with the merchants on the retrieved list; (iii) select a merchant from the retrieved list and receive a token to conduct a staged transaction with the selected merchant; (iv) conduct the staged transaction with the merchant by the submission of the token to the merchant as form of payment; and (v) use the token, after conducting the staged transaction with the selected merchant, to gain access to a social media portal and input the consumer's opinion about the selected merchant's performance of the staged transaction, whereby other such consumers can review the consumer's review of the merchant before deciding to do business with the merchant.

The e-wallet service provides a portal having a search engine into which registered consumers can input goods and services that they want to purchase. This function has a built in search engine the filter the search results, for instance, the consume can specify that the engine return all inexpensive merchants that other consumers have rated as ‘ three or a greater number of stars’ or having only better or the best ratings from the other consumers who reviewed those merchants. As such, the search engine will return a list of merchants that are, according to past consumers doing business with the merchants on the list, least expensive with better or best ratings by actual paying customers of those merchants.

The list of merchants returned to the consumer via the search engine can include an advertisement (ad) for each such merchant. The ad can include an offer, rebate, discount, or special deal for doing business with the merchant. The order in which the ads are returned to the consumer can be a functions of the compensation paid by each merchant to the e-wallet service in return for accepting and disseminating each merchants ads. As such, the first ads seen by the consumer will be those ads for which the e-wallet service was compensate the most. Thus, merchants registering with the e-wallet service bid, by category, to have their ads displayed in the highest order of priority so as to be seen by consumers who ask to see goods and services in respective categories.

By way of example, a consumer can operate a web enabled client to browse to the search engine and input a request to see merchant offers of any of several categories of goods and services, such as coffee, lunch, paint, hardware, electronics gadgets, etc. Merchants selling the requested category would be returned in the order of their highest bid to the e-wallet service. The bid-winning ads would be seen first by the consumer at the top of a display that renders the list. Stated otherwise, the highest paid ad accepted by the e-wallet service would be seen by the consumer first for a consumer-selected category.

When the search engine returns a list of merchants to the consumer's web enabled computing apparatus, the e-wallet entity allows the consumer to study reviews of each merchant that have been submitted by other consumers who did business with the merchant. As such, before the consumer decides to do business with the merchant, the consumer's studying of the reviews of other consumers will allow the consumer to make an informed decision before making a selection of the merchant and receiving a token for a staged transaction with the merchant. As stated the consumer will read reviews from the e-wallet service that have been submitted only by consumer that are actual paying customers of the merchant through the e-wallet service. The reviews by the actual paying customers are posted at the e-wallet service's social network portal for this purpose. Stated otherwise, each consumer using the e-wallet service may use the reviewers' discussion of merchants in order to make an informed decision based upon an actual paying experience of other consumers with the merchant before the consumer selects that merchant.

The consumer's selection of an offer from a merchant in the hierarchical list results in a token for staged transaction with the merchant being sent to the consumer's web enabled computing apparatus. The token can be coupled or logically associated to the terms and conditions of the merchant's offer. As such, the consumer will see the result of the offer when checking out at the merchant's POS, for instance, by paying less than retail due to the offer (e.g.; 20% off a good or service at the merchant's store).

In another implementation where the consumer has not searched by category, but has simply searched by merchant and has received a token to use at the merchant w/I the predetermined time window, the consumer can receive ads after the token is received but before conducting the staged transaction with the merchant. The ads that the consumer receives can be from manufacturers who stock products at the merchant's store. Each such ad can be selected or rejected by the consumer prior to conducting the staged transaction with the merchant. The POS of the merchant can pick up the SKU/UPC symbols of a product so advertised to the consumer. The token given by the consumer to the merchant to conduct the staged transaction can be used to match against ads previously selected by the consumer in order to award the consumer with a discount or offer set forth in the ad that was selected by the consumer. Alternatively, the merchant can simply enter, at the POS, codes corresponding to the ads selected by the consumer. As such, the POS receives both the selected offers and the token so that the consumer gets the discounts of the selected offers.

The consumer gives the token at the POS, instead of using cash, check, or card, in order to conduct the staged transaction with the merchant previously selected by the consumer. The selected merchant corresponding to the token might be charged a percentage of the currency amount of the transaction as a ‘finder's fee’ to the e-wallet service. Of course, other revenue models for the e-wallet service are also contemplated.

After the consumer has conducted the staged transaction with the selected merchant to which the token was submitted, the same token can be used by the consumer to gain access to a social media portal where the consumer can store a review of their experience with the merchant. As such, the e-Wallet service provides a social network that allows consumers to rate merchants with whom staged transactions were conducted. Access control can be limited to just one review by one consumer for each token such that the token is has a one-time-only use for each staged transaction that the consumer conducted with the merchant. In a variation of the forgoing, if a consumer is about to submit a negative review to the social media portal for the merchant, the merchant can provide predetermined messages that can be returned to the consumer in order to stop the submission in exchange for the consumer accepting a new and perhaps best discount offer to ‘make things right’ with the consumer, and thereby allow the consumer to re-think the giving of a negative rating. Of course, in this scenario, the e-wallet service can derive from a staged transactions database whether, and how often, the consumer has previously done business with the merchant. This derivation will allow merchant to prevent consumer from gamesmanship of the system or to taking advantage of the good will of the merchant in order to gain an unmerited discount on a future transaction.

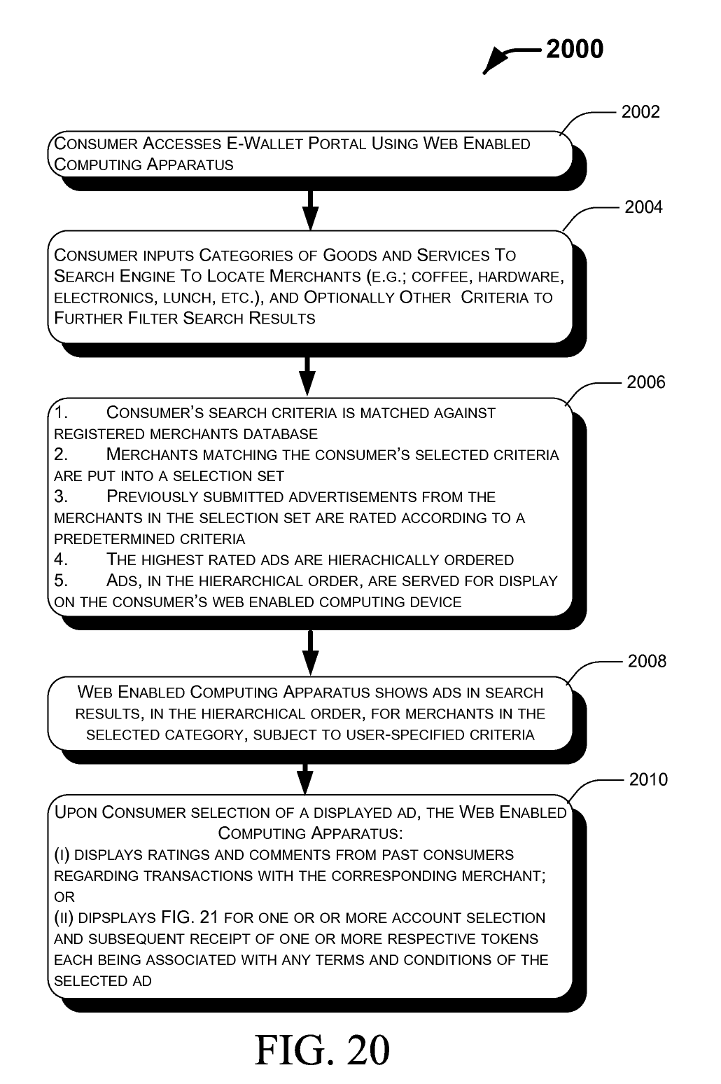

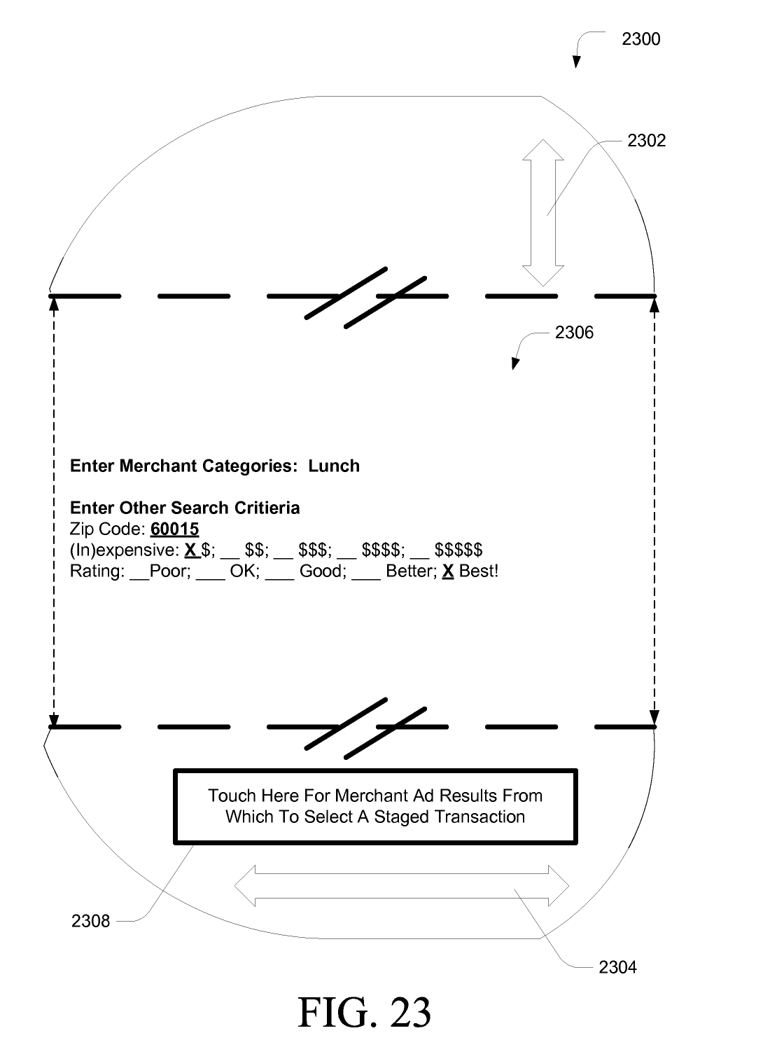

By way of examples of some of the foregoing implementations, and referring now to FIGS. 20-31, FIG. 20 illustrates a flow chart of an exemplary alternative method 2000, which can be practiced in the environments of FIGS. 1-3 and 19. At step 2002 of method 200, a consumer who is registered with an e-wallet web service assesses the service. At step 2004, the consumer inputs a category of a merchant into a search engine and optionally other search criteria. By way of example, and not by way of limitation, FIG. 23 shows an exemplary exploded user interface 2300 rendered at on a web enabled computing apparatus that a consumer can use, in accordance with the method of FIG. 20, to input a category of a merchant into a search engine and optionally other search criteria at shown at reference numeral 2306. When the consumer's input is complete, an icon seen at reference numeral 2308 can be activated by the consumer to initiate the search engine results retrieval. Vertical and horizontal navigation icons, respectively at reference numerals 2302 and 2304, can be activated to scroll respectively up and down so that the consumer can view more the user interface.

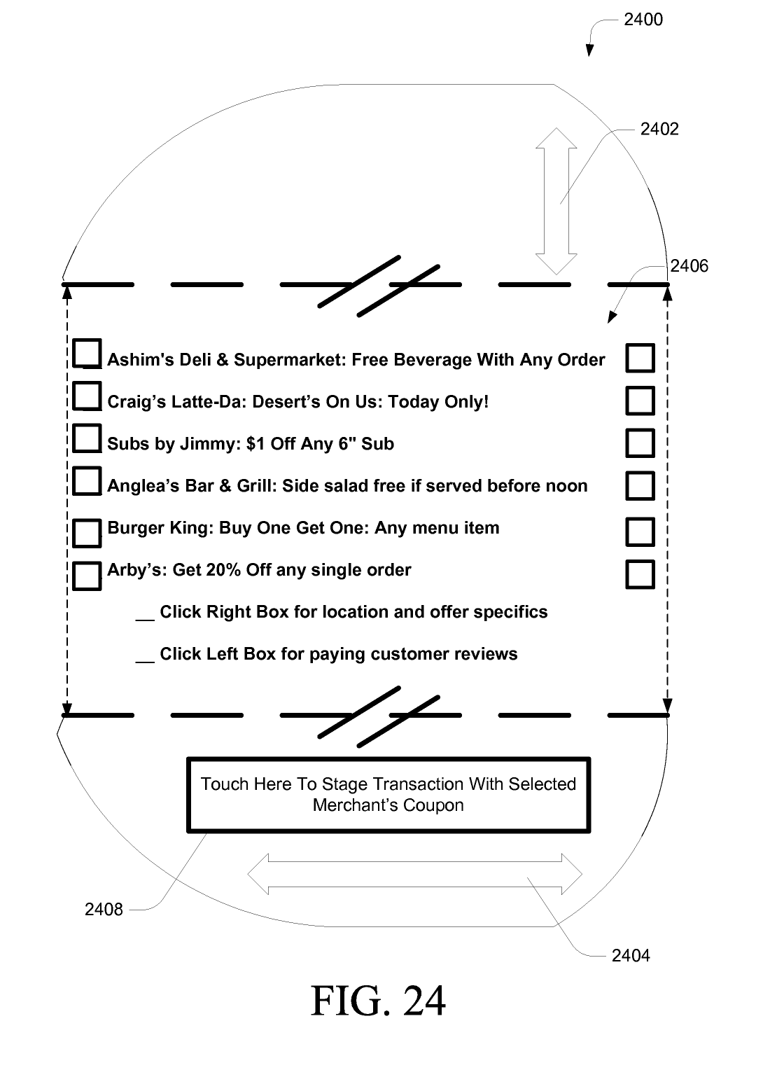

At step 2006, the e-wallet service using the consumer's search criteria to find matches against merchants in a database that are registered with the e-wallet service. Those merchants matching the consumer's selected criteria are put into a selection set. Previously submitted advertisements from the merchants in the selection set are rated according to a predetermined criteria. The highest rated ads are hierarchically ordered into a list of merchants and their respective ads. The ads, in the hierarchical order, are served for display on the consumer's web enabled computing device at step 2008. By way of example, and not by way of limitation, FIG. 24 shows an exemplary exploded user interface 2400 rendered at on a web enabled computing apparatus that a consumer can use, in accordance with the method of FIG. 20, to see a hierarchical list of advertisements 2406 from merchants according to the input search criteria with respect to FIG. 23. Vertical and horizontal navigation icons, respectively at reference numerals 2402 and 2404, can be activated to scroll respectively up and down so that the consumer can view more the user interface.

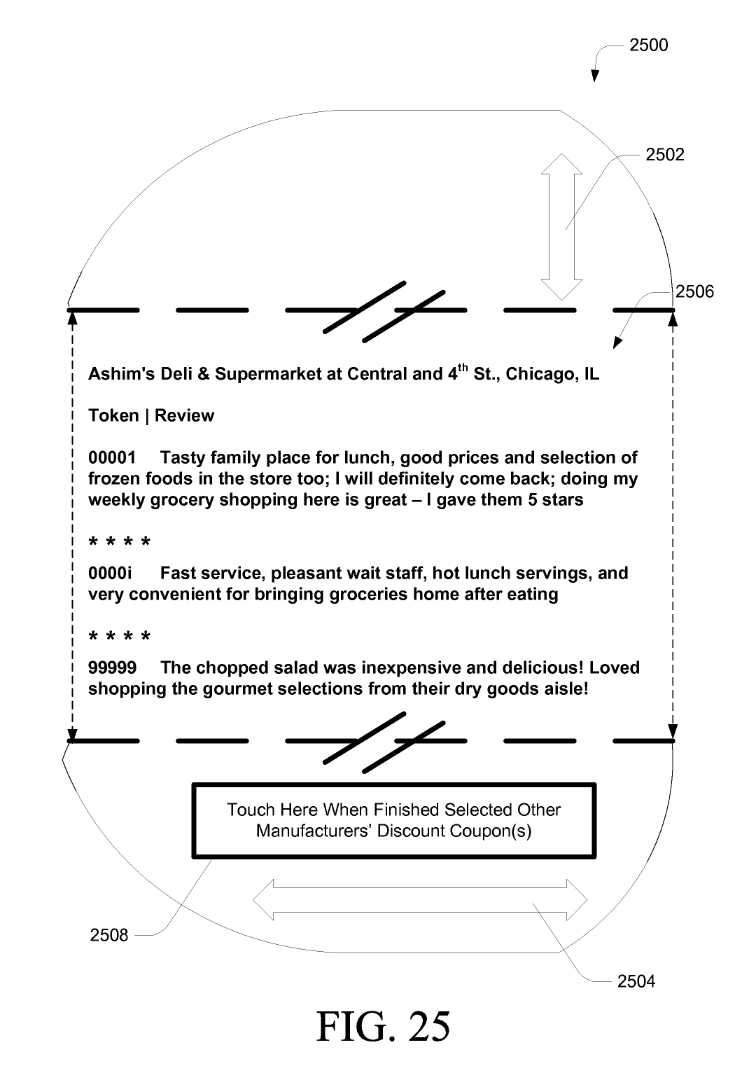

At step 2010 of the method 2000, the consumer can make different types of selections of one of the displayed ads from a screen or monitor rendered on the web enabled computing apparatus. One type of selection that the consumer can make of a merchant's ad is to select a box to the right of a merchant's advertisement from the list 2406 of FIG. 24, resulting in a request a display reviews or ratings and/or comments from past consumers regarding transactions with the corresponding merchant. By way of example, and not by way of limitation, FIG. 25 shows an exemplary exploded user interface (UI) 2500 rendered at on a web enabled computing apparatus. UI 2500 allows the consumer, in accordance with the method of FIG. 20, to see past ratings and comments at reference numeral 2506 from other consumers that have conducted transactions in the past with the merchant. Each such rating was made by the other consumer using a token received from the e-wallet service. Vertical and horizontal navigation icons, respectively at reference numerals 2502 and 2504, can be activated to scroll respectively up and down so that the consumer can view more the user interface.

Another type of selection that the consumer can make of a merchant's advertisement from the list 2406 on FIG. 24 of UI 2400, as set forth at step 2010 of method 2000, is to select the merchant with whom the consumer wishes to stage a transaction. By way of example, and not by way of limitation, the consumer can select a box to the left of a merchant's advertisement from the list 2406 of FIG. 24 and then activate an icon at reference numeral 2408 of FIG. 24 in order to stage the transaction with that merchant.

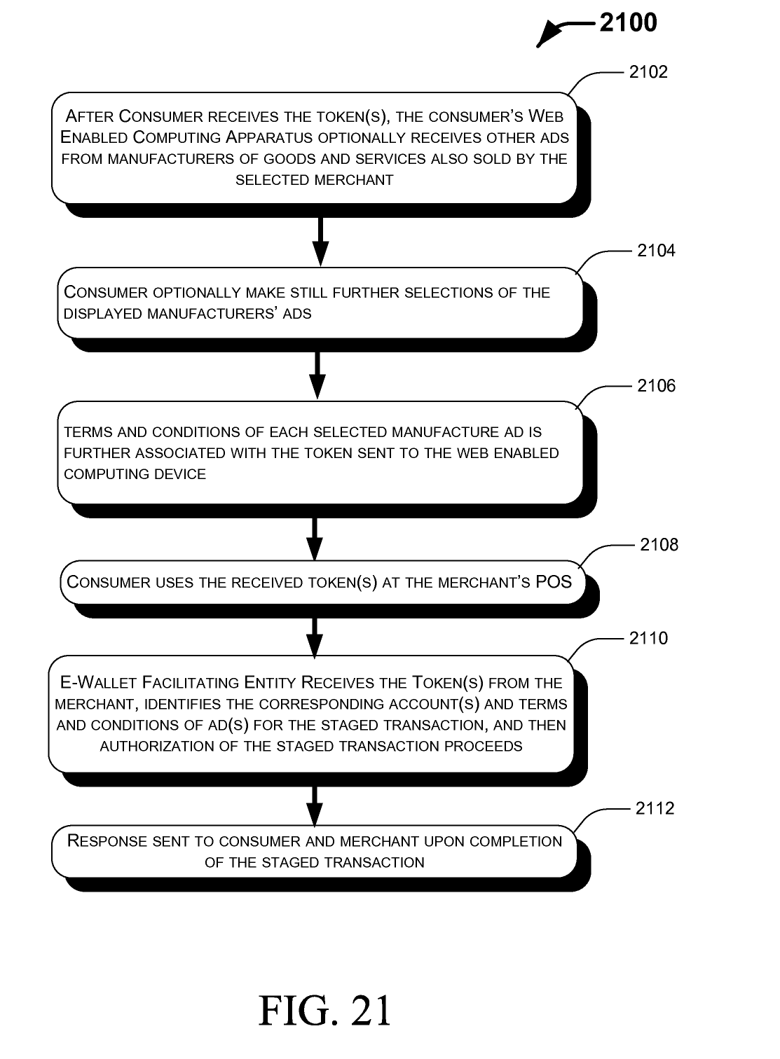

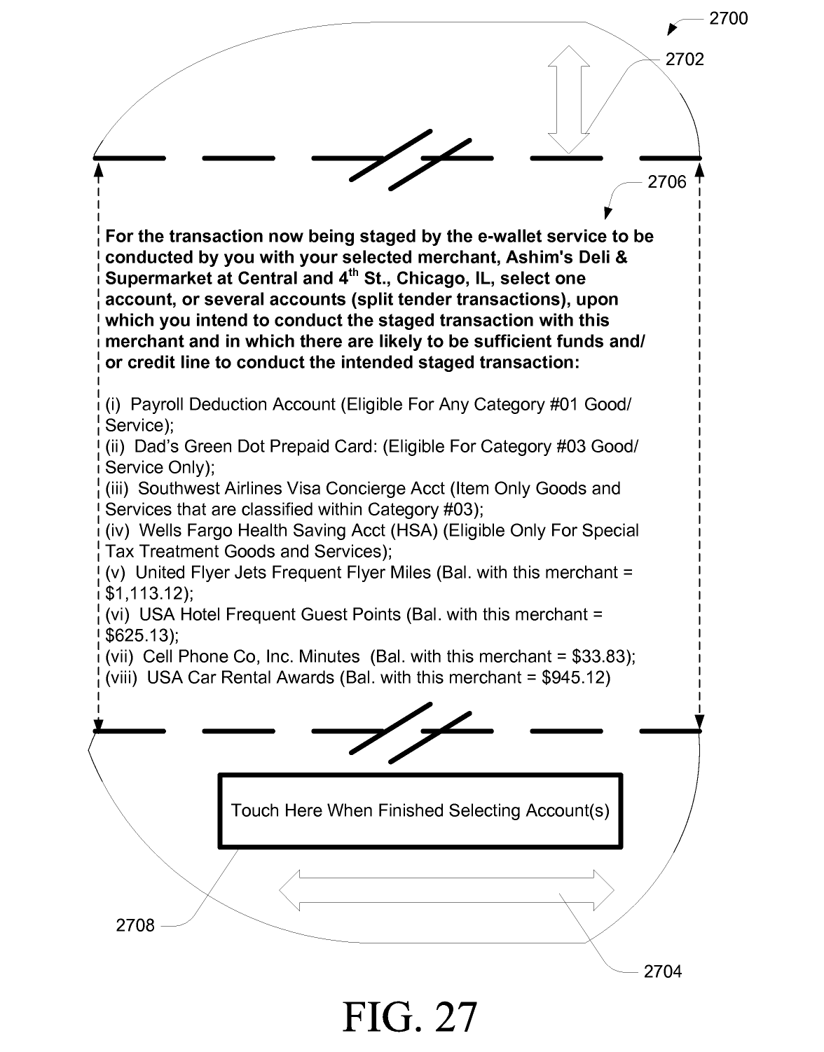

Once the merchant has been selected, the consumer can pick the account or accounts that will be used to pay the selected merchant for the staged transaction. By way of example, and not by way of limitation, FIG. 27 shows an exemplary exploded user interface (UI) 2700 rendered on a web enable computing apparatus used by the consumer. UI 2700 show a list of accounts that the consumer has previously registered for use with the e-wallet service. The consumer ‘clicks’ on one or more displayed account to indicate use of same for the staged transaction. Note that some accounts have non-financial currency balances (e.g.; loyalty program currency) for which the balance thereof has been converted, in real time, into financial currency according to a predetermined arrangement between the issuer of that account and the selected merchant. Vertical and horizontal navigation icons, respectively at reference numerals 2702 and 2704, can be activated to scroll respectively up and down so that the consumer can view more the user interface. When the consumer has completed the selection of registered account(s) upon which the staged transaction will be conducted, the consumer activates an icon at reference numeral 2708 to proceed from step 2010 for method 2000 in FIG. 20 to step 2102 of method 2100 of FIG. 21.

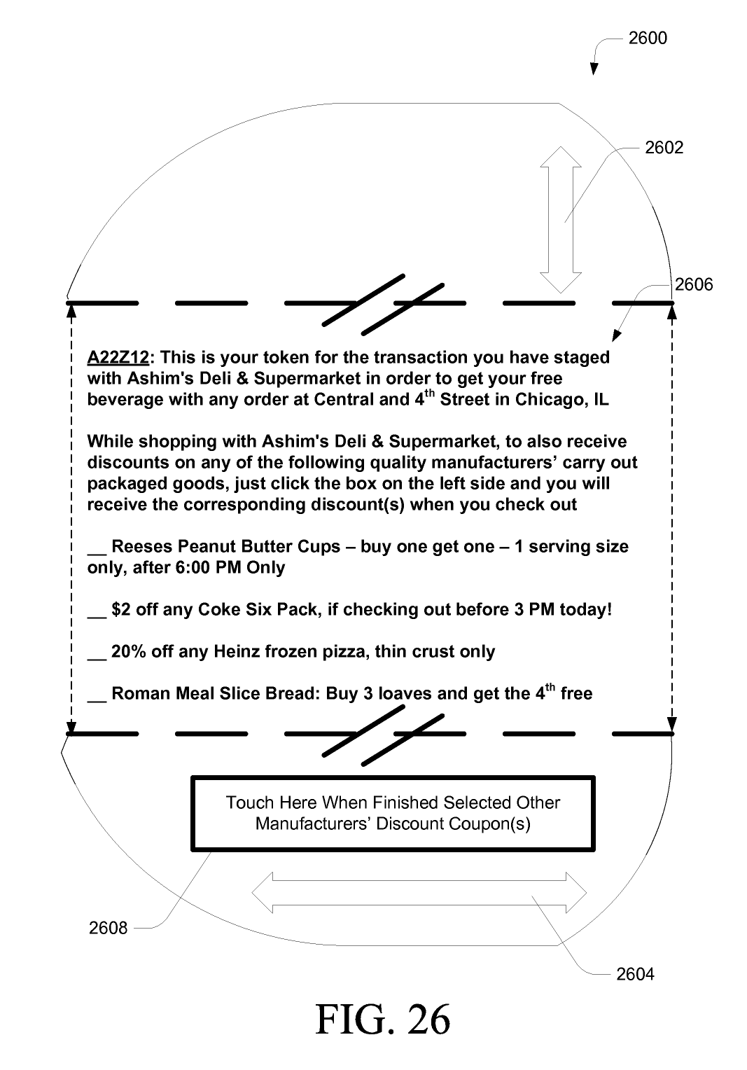

FIG. 21 illustrates a flow chart of an exemplary extension to the method 2100 of FIG. 20. At step 2102 of method 2100, after the consumer receives the token, other advertisements can also be received by the consumer. By way of example, and not by way of limitation, FIG. 26 shows an exemplary exploded user interface (UI) 2600 rendered at on a web enabled computing apparatus where a consumer can see, in accordance with the steps 2010 of method 2000 of FIG. 20 and step 2102 of a method 2100 of FIG. 21, a token that has been received. UI 2600 shows a display 2606 of other advertisements for other goods and services sold by the selected merchant (“Ashim's Deli & Supermarket at Central and 4th Street in Chicago, Ill.”). Vertical and horizontal navigation icons, respectively at reference numerals 2602 and 2604, can be activated to scroll respectively up and down so that the consumer can view more the user interface. Any such ad that is selected by the consumer's activation of an corresponding icon on UI 2600 at step 2104 of method 2100, after activation of an icon 2608 on UI 2600, will be associated by the e-wallet entity with the token at step 2106 of method 2100.

At step 2108 of method 2100, the consumer submits the token to the selected merchant in order to conduct the staged transaction. At step 2110, when the e-wallet facilitating entity receives the token from the merchant in an authorization process incident to the staged transaction, the e-wallet facilitating entity apply the terms and conditions associated with the token as correspond to the selected advertisements. The staged transaction, when authorized, can be processed for payment of the merchant on the registered account corresponding to the token. Optionally, at step 2112, the e-wallet facilitating entity can coordinate one or more message to the consumer and selected merchant upon a completion of the staged transaction.

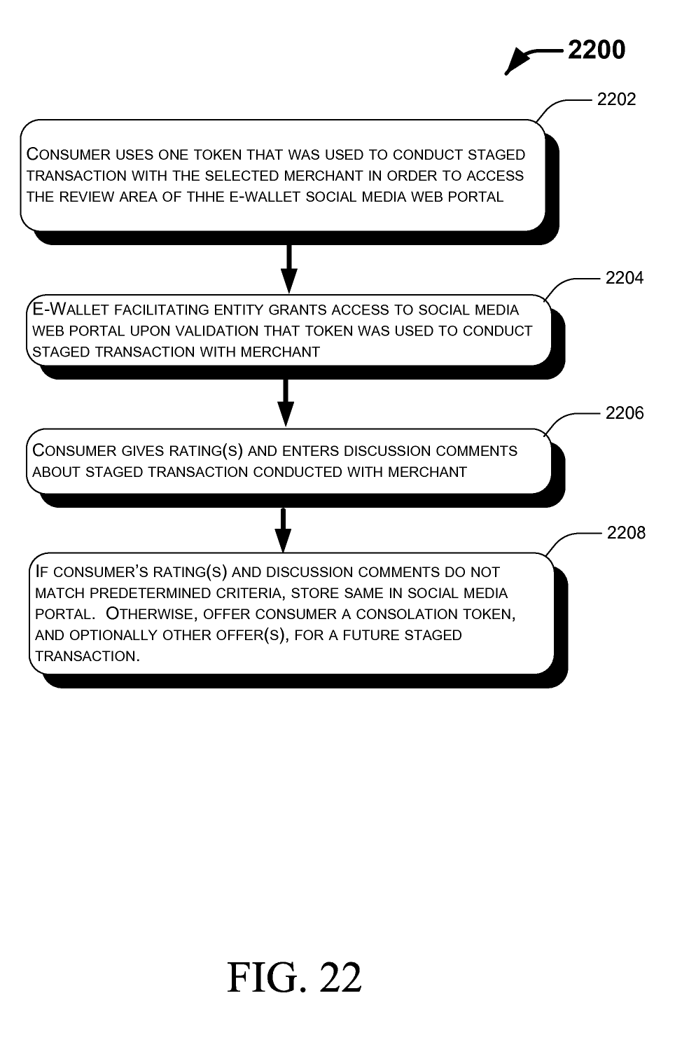

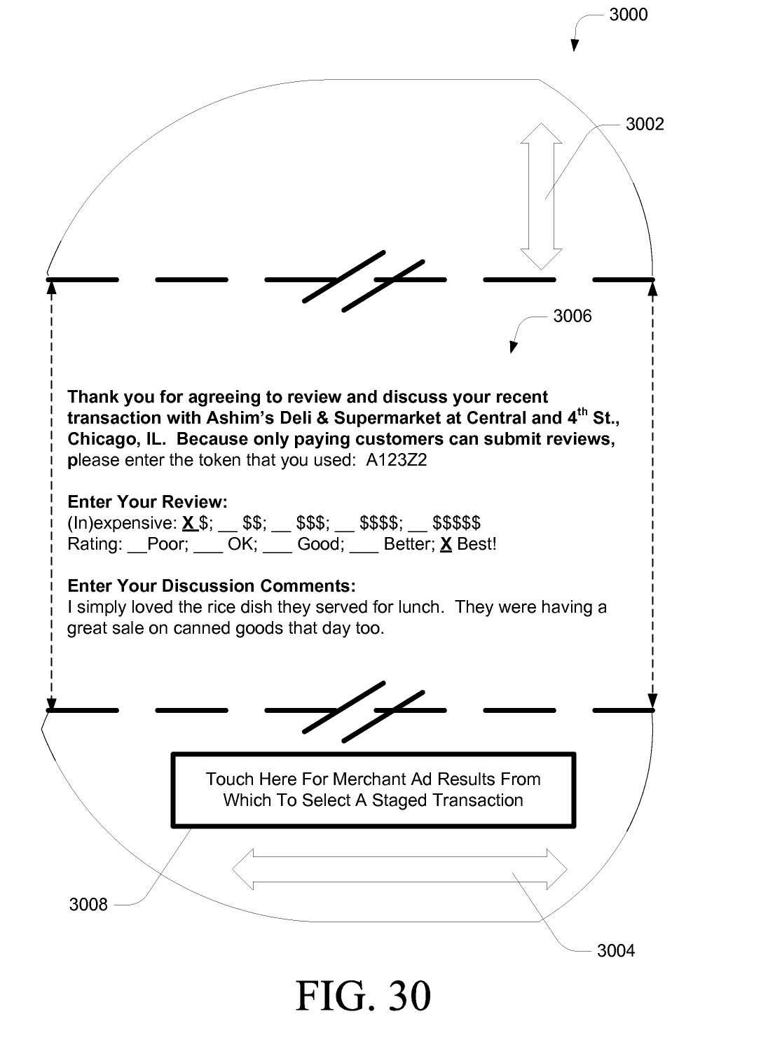

FIG. 22 illustrates a flow chart of an exemplary extension to the method 2100 of FIG. 21. At step 2202 of FIG. 22, the consumer accesses a social media portal for the e-wallet service using the token that the consumer used to conduct the staged transaction with the selected merchant. The e-wallet facilitating entity, at step 2204, controls access to the consumer by matching the token against staged transaction were authorized or otherwise completed. Once the consumer is granted access to the e-wallet social media portal, at step 2206 of method 2200, the consumer gives an opinion, rates or reviews, and optionally comments, on the merchant's goods or services. By way of example, and not by way of limitation, FIG. 30 shows an exemplary exploded user interface (UI) 3000 rendered at on a web enabled computing apparatus where a consumer, in accordance with step 2202 a method 2200 of FIG. 22, inputs the token used to conduct the staged transaction in order to further input a rating or review and optionally comments for the staged transaction. The consumer's review is input in the area of UI 3000 seen at reference numeral 3006. Vertical and horizontal navigation icons, respectively at reference numerals 3002 and 3004, can be activated to scroll respectively up and down so that the consumer can view more the user interface.

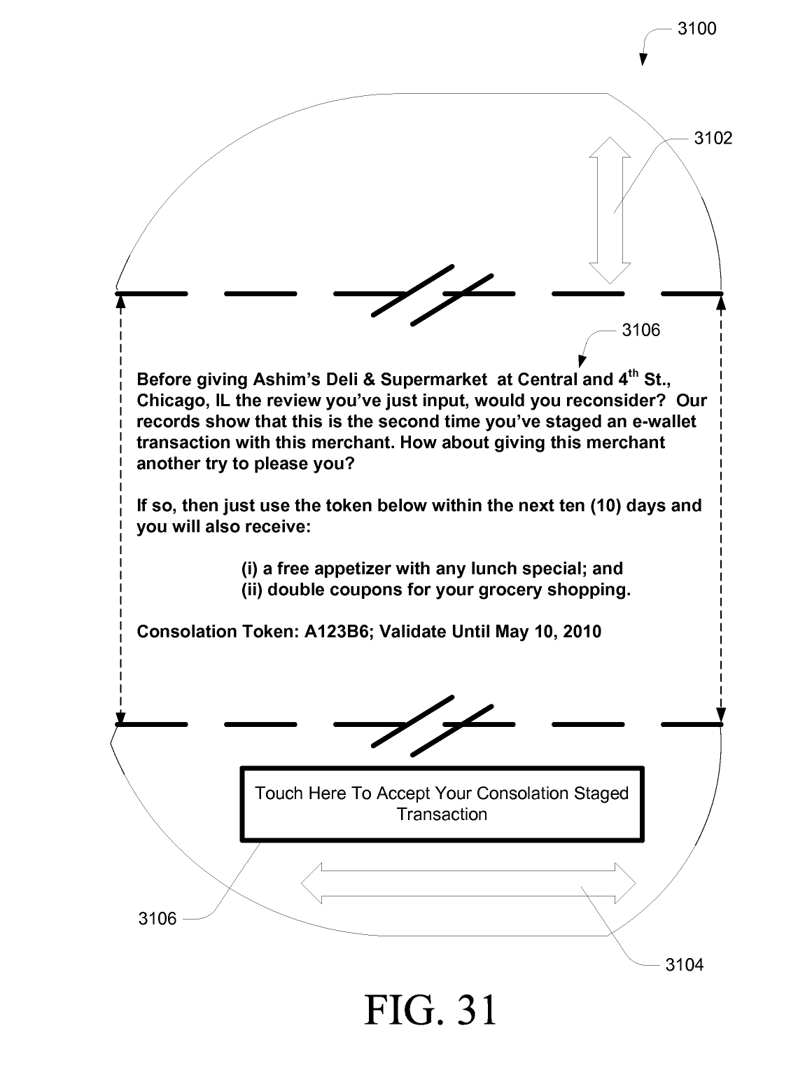

After the consumer has activated the icon at reference numeral 3008 of UI 3000, the e-wallet facilitating entity stores the consumer's input so as to be accessible to other consumers. Optionally, at step 2208, the consumer's input can be matching against predetermined criteria to determine whether a negative, unfavorable or undesirable assessment of the merchant is about to be submitted. If so, then the e-wallet service can sent to the consumer's web enabled computing apparatus another token along with an offer of a discount or other incentive from the merchant. This consolation token will allow the consumer to conduct another and future staged transaction with the merchant so that the consumer can re-evaluate their negative opinion of the merchant. Also at step 2208, the e-wallet service can determine whether the consumer has ever done business with the merchant in the past. If the consumer is a frequent or regular shopper with the merchant, as determined from historical data stored in a database of past staged transactions, then the negative rating may be treated differently. For instance, the e-wallet service may disregard or alter communications with the consumer before discarding or ignoring the consumer's negative input. As such, the e-wallet service may have a logical module that allows merchants to prevent consumers from giving negative reviews in order to take advantage of the merchant's willingness to give favorable terms on a future transaction in order to avoid getting a negative review. By way of example, and not by way of limitation, FIG. 31 shows an exemplary exploded user interface (UI) 3100 rendered at on a web enabled computing apparatus where a consumer, in accordance with step 2208 of the method of FIG. 21, is offered a consolation token. The consolation token, shown at in the display area on UI 3100 seen at reference numeral 3106, can be used by the consumer to conduct a future staged transaction in exchange for withholding a previously input rating or review that matches a predetermined criteria. Also seen at reference numeral 3106 is a special discount offer incentive that will be associated with the consolation token by the e-wallet facilitating entity. As such, the consumer experience at the POS of the merchant will be to receive the special discount offer incentive when the consolidation token is given to conduct the staged transaction with the merchant. Vertical and horizontal navigation icons, respectively at reference numerals 3102 and 3104, can be activated to scroll respectively up and down so that the consumer can view more the user interface.

After conducting the staged transaction with the consolation token, the consumer will again be invited to use the consolation token to access the social media portal of the e-wallet service to give a review of the merchant (see FIG. 22 steps 2202-2206 and FIG. 30).

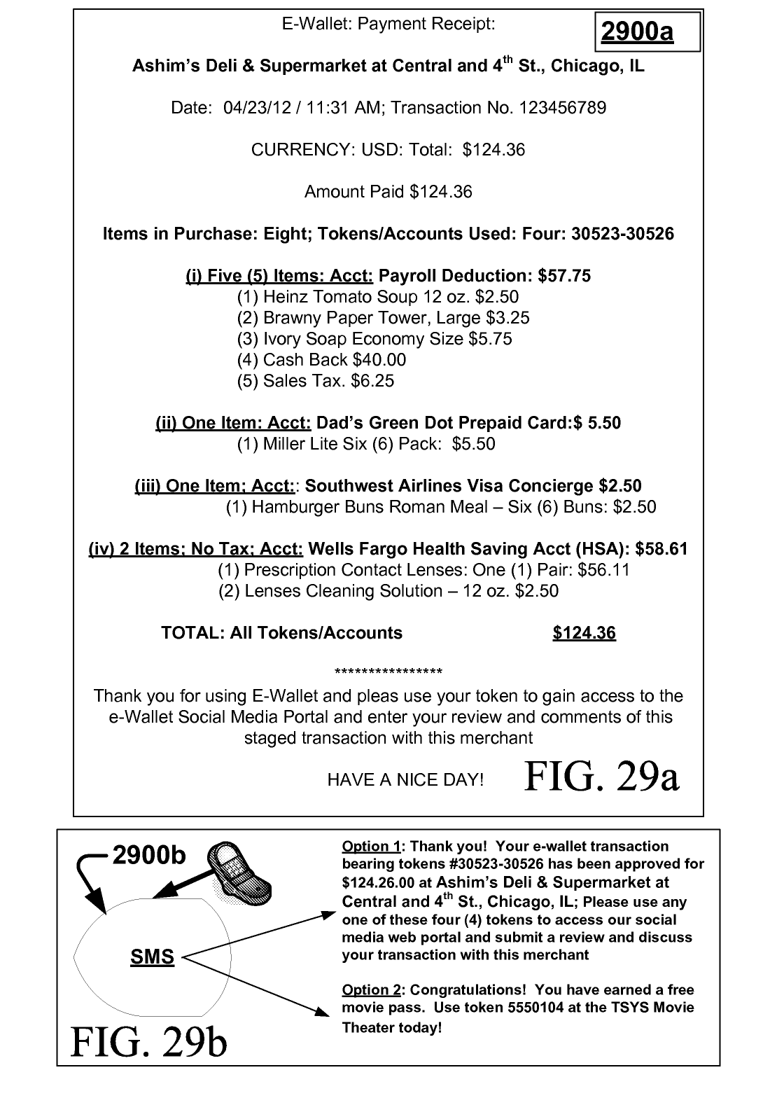

FIG. 29 shows an User Interface (UI), depicted as an exploded screen shot 2900, which can be rendered at a Point of Service terminal (POS), or at an electronic peripheral device in communication with the POS. The UI can be complimented by input device(s) for use by an account holder and/or POS operator to input one or more tokens each respectively representing an account. Each token would have been previously retrieved from an e-wallet Facilitating Entity and would have been returned, upon request for same by a consumer, for accounts registered with the E-wallet Facilitating Entity. The token can be received via a text message, an e-mail, a web browser web page on a web-enabled portable consumer electronic device (e.g., a cellular telephone), etc.

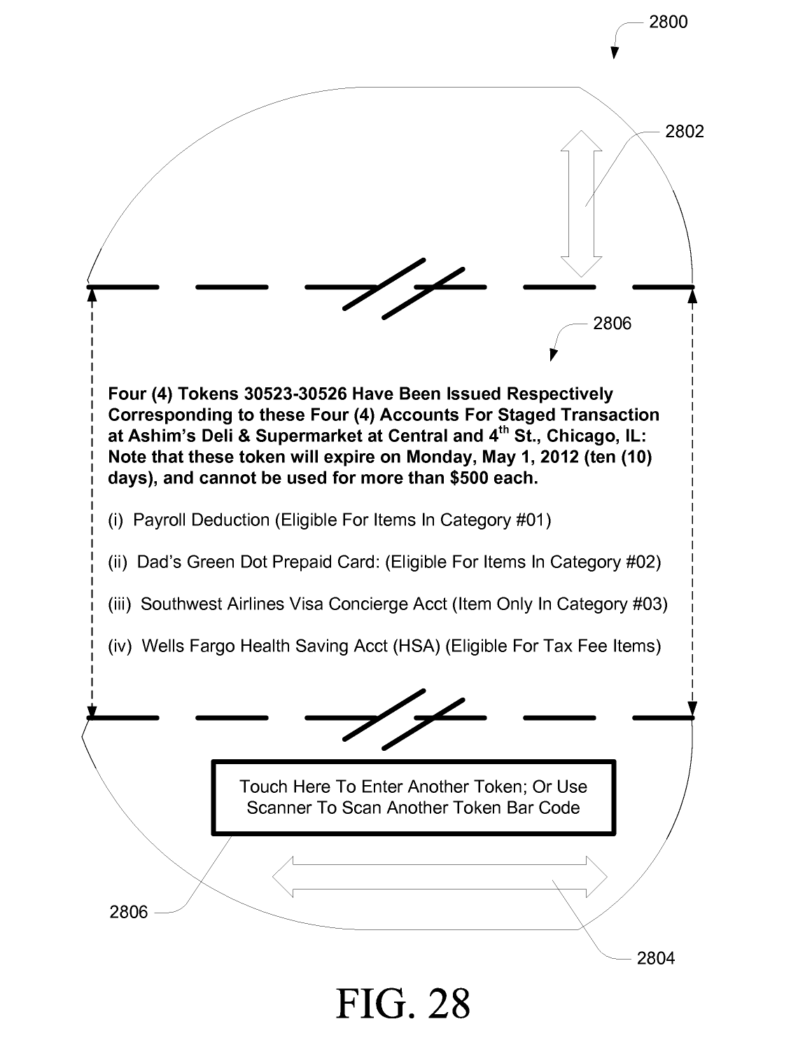

Each received token can be entered into the UI which, as shown in FIG. 28, has received four (4) such tokens (30523-30526) corresponding to four (4) accounts upon which a cashless transaction with the merchant “Ashim's Deli & Supermarket at Central and 4^{th} St., Chicago, Ill.” can be conducted: (i) Payroll Deduction account; (ii) Dad's Green Dot Prepaid Card; (iii) Southwest Airlines Visa Concierge Acct; and (iv) Wells Fargo Health Saving Account (HSA). Also shown, for each account, there is a predetermined identifier showing the types of items that are eligible to be purchased with the account. As such, each token that is input into the UI corresponds to an account to be used to pay for one or more items being purchased in a cashless transaction conducted in the environment of FIG. 3. UI has a vertical scroll icon 2902 and a horizontal scroll icon 2904 which can be activated to view more visually displayed subject matter on screen shot 2900. A touch button icon 2906 prompts the user to enter another token.

FIG. 29a shows exemplary paper receipt 2900a rendered by POS 304 or by a peripheral printer in communication with POS 304. As shown, the four (4) accounts corresponding to four (4) tokens (30523-30526) were input via the UI of FIG. 27. These four (4) accounts were used to purchase eight (8) items from a merchant labeled as “Ashim's Deli & Supermarket at Central and 4^{th} St., Chicago, Ill.”. The date, time and transaction code of the purchase was 04/23/12/11:31 AM; Transaction No. 123456789. The total amount of the purchase was $124.36 US.

Five (5) items were purchased using a payroll deduction account for a total of $57.75 US, where these items were: (1) Heinz Tomato Soup 12 oz. $2.50; (2) Brawny Paper Tower, Large $3.25; (3) Ivory Soap Economy Size $5.75; (4) Cash Back $40.00; and (5) Sales Tax for the entire transaction in the amount of $6.25. One (1) item was purchased using an account labeled as “Dad's Green Dot Prepaid Card” for a total of $5.50 US, where the item was “Miller Lite Six (6) Pack”. One (1) item was purchased using an account labeled as “Southwest Airlines Visa Concierge” for a total of $2.50 US, where the item was “Hamburger Buns Roman Meal”. Two (2) items were purchased using an account labeled as “Wells Fargo Health Saving Acct (HSA)” for a total of $58.61. No tax was added to the latter items on the HSA, as they were all eligible for a special tax treatment designed specifically for healthcare items: (1) Prescription Contact Lenses: One (1) Pair: $56.11; and (2) Lenses Cleaning Solution—12 oz. $2.50.

FIG. 29b shows two optional text messages 2900b sent to the consumer 108's cellular telephone which confirm completion of the transaction which had been previously ‘staged’ with the merchant labeled as “Ashim's Deli & Supermarket at Central and 4^{th} St., Chicago, Ill.”. In Option 1, a text message is sent to the consumer's cellular telephone that contains a message thanking the consumer for using the virtual wallet in a transaction with tokens #30523-30526 which was approved for $124.36 in a previously staged transaction for use at the merchant labeled “Ashim's Deli & Supermarket at Central and 4th St., Chicago, Ill.”. Option 1 further extends an invitation to the consumer to use any one of the four (4) tokens in order to gain access to the e-wallet facilitating entity's social media web portal where the consumer can submit a review and discuss the consumer's opinion of the staged transaction that the consumer conducted with the merchant.

In the “Option 2” at reference numeral 2900b of FIG. 29, a token has been issued to another participating merchant. As shown, when this token “5550104” is presented to a POS at the “TSYS Movie Theatre” merchant, the consumer's account will not be assessed an entrance fee to see a motion picture. Rather, the token will only be used to grant access to the theatre. As such, implementations contemplate token issuance and usage for accepting a loyalty reward of a specific item for a specific merchant's location. The specific item can be indicated to the consumer by use of a name, description, Stock Keeping Unit (SKU), Universal Product Code (UPC), bar code, product level data, or other identifiers. Accordingly, the token so issued need not involve a financial transaction on an account registered to the consumer by the e-wallet web service.

In general, implementations of methods disclosed herein can be performed both by application specific integrated circuits as well as by general purpose computers that become special purpose computers when programmed to be perform steps of the disclosed methods. Moreover, implementations of methods disclosed herein include steps each of which can be performed by hardware executing software.

As used herein a ‘web service’ is a software system designed to support interoperable machine-to-machine interactions over a network or a collection of networks, where each such machine can be a web enabled mobile computing apparatus, cellular telephones having access to the Internet and/or the World Wide Web, a desktop personal computer, web servers, routers, switching machines, main frame computers, etc. The web service can be an Internet application programming interfaces (API) that can be accessed over a network, such as the Internet, and executed on a remote system hosting the requested services. In some implementations, however, the ‘web service’ is understood to have the functionality provided by Object Management Group's (OMG) Common Object Request Broker Architecture (CORBA), Microsoft's Distributed Component Object Model (DCOM) or SUN's Java/Remote Method Invocation (RMI). In some implementations, clients and servers communicate over the HTTP protocol used on the World Wide Web or by use of Extensible Markup Language (XML) messages that follow the Simple Object Access Protocol (SOAP) standard, and similar standards. In other implementations, the web service provides an interface for a service oriented architecture (SOA), in which Web-based applications dynamically interact with other Web applications using open standards that include XML running over HTTP, Universal Description, Discovery, and Integration (UDDI), and SOAP.

The software components or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

It should be understood that elements or functions of the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A method comprising a plurality of steps each being performed by apparatus executing instructions, wherein the steps include:
receiving a request to conduct a transaction with a merchant on an account for a purchase of a good or service with an account holder, wherein the account is issued by an issuer to an account holder;
determining whether the request is authorized by the account holder; and
if the request is authorized by the account holder, sending, in response to the receiving of the request, a token to a logical address corresponding to the account holder, wherein the token is:
representative of the account issued by the issuer to the account holder; and
sufficient for the one said merchant in the list to conduct the transaction on the account for the purchase of the good or service;
receiving a transmission that includes an indicator that the token has been submitted to the one said merchant;
comparing the time that the transmission was received to the time that the token was sent to the logical address corresponding to the account holder to ascertain whether a difference from the comparison exceeds a predetermined time limit;
if difference from the comparison is not greater than the predetermined time limit, sending a message to a logical address corresponding to the merchant, wherein the message includes an authorization to conduct the transaction on the account for the purchase of the good or service.

2. The method as defined in claim 1, wherein if difference from the comparison is not greater than the predetermined time limit, the steps further comprise sending a confirmation of the conducting of the transaction to the logical address corresponding to the account holder.

3. The method as defined in claim 1, wherein the token comprises a string of a number of characters that is different that the number of characters in a Primary Account Number (PAN) that identifies the account issued to the account holder.

4. The method as defined in claim 3, wherein the issuer of the account is the issuer of the token.

5. The method as defined in claim 1, wherein:
the token comprises a string of a number of integers that is the same number of integers in a Primary Account Number (PAN) that identifies the account issued to the account holder; and
the integers of the token are different than the integers of the PAN.

6. The method as defined in claim 5, wherein the issuer of the account is different than the issuer of the token.

7. The method as defined in claim 1, wherein:
the method further comprises, prior to the receiving of the request to conduct the transaction with the merchant, receiving a registration of the account to receive one or more future issued said tokens; and
the determining whether the request is authorized by the account holder further comprises determining that the account has been registered by the receipt of the registration of the account.

8. The method as defined in claim 1, wherein the determining whether the request is authorized by the account holder further comprises determining that the request was received from the logical address corresponding to the account holder.

9. The method as defined in claim 1, wherein:
the steps further comprise, after the sending of the message to the logical address corresponding to the merchant, sending a confirmation of the conducting of the transaction to the logical address corresponding to the account holder; and
the confirmation comprises a different said token that is:
not representative of the account issued by the issuer; and
sufficient for a different merchant to conduct a different transaction on an account corresponding to the token for a purchase of a good or service.

10. The method as defined in claim 1, wherein the steps further comprise:
receiving, the token and an evaluation of the one said merchant in the list; and
determining whether the transaction has been conducted by the account holder submitting the token to the one said merchant in the list; and
if the transaction has been conducted by the account holder submitting the token to the one said merchant in the list, storing, in a database, the evaluation so as to be associated with the one said merchant in the list, wherein the database contains a plurality of said merchants and their respective said evaluations submitted by other said account holders who had conducted respective said transactions with the plurality of said merchants.

11. The method as defined in claim 10, wherein the steps further comprise:
receiving a request containing an identifier for a merchant and a logical address;
determining whether the identifier for the merchant corresponds to at least one said merchant in the plurality of said merchants that are contained in the database; and
if the identifier for the merchant corresponds to at least one said merchant in the plurality of said merchants that are contained in the database, then sending, to the logical address, one or more said evaluations contained in the database that respectively correspond to the at least one said merchant in the plurality of said merchants that are contained in the database.

12. A non-transitory computer readable medium comprising instructions which, when executed by a computing apparatus, performs the method of claim 1.

13. A method comprising a plurality of steps each being performed by computing apparatus executing computer software, wherein the steps include:
receiving criteria in a request for a list of merchants each of whom can conduct a transaction on an account for a purchase of a good or service with an account holder, wherein the account is issued by an issuer to an account holder;
determining, using the criteria, whether the request is authorized by the account holder; and
if the request is authorized by the account holder:
retrieving, using the criteria, the list of merchants, wherein at least one of the merchants in the list satisfies the criteria;
sending, in response to the receiving of the request, the list of merchants to a logical address corresponding to the account holder;
receiving a selection of one said merchant in the list;
sending to the logical address corresponding to the account holder, in response to the receiving of the selection of the one said merchant, a token that is:
representative of the account issued by the issuer to the logical address corresponding to the account holder; and
sufficient for the one said merchant in the list to conduct the transaction on the account for the purchase of the good or service;
receiving information confirming that the transaction has been conducted by the account holder submitting the token to the one said merchant in the list; and
sending a confirmation of the conducting of the transaction to the logical address corresponding to the account holder.

14. The method as defined in claim 13, wherein the request is received from the logical address corresponding to the account holder.

15. The method as defined in claim 13, wherein the token comprises a string of a number of characters that is different that the number of characters in a Primary Account Number (PAN) that identifies the account issued to the account holder.

16. The method as defined in claim 15, wherein the issuer of the account is the issuer of the token.

17. The method as defined in claim 13, wherein:
the token comprises a string of a number of integers that is the same number of integers in a Primary Account Number (PAN) that identifies the account issued to the account holder; and
the integers of the token are different than the integers of the PAN.

18. The method as defined in claim 17, wherein the issuer of the account is different than the issuer of the token.

19. The method as defined in claim 13, wherein:
the criteria comprises an identifier for a geographic location; and
the retrieving of the list of merchants further comprises:
accessing a database containing a plurality of said merchants and their respective geographic locations, wherein each of the merchants in the database can conduct the transaction on the account for the purchase of the good or service with the account holder; and
forming the list of merchants from the merchants in the database that have a geographic location within a predetermined distance from the geographic location corresponding to the identifier in the criteria.

20. The method as defined in claim 13, wherein:
the method further comprises, prior to the receiving of the criteria, receiving a registration of the account to receive one or more future issued said tokens; and
the determining whether the request is authorized by the account holder further comprises determining that the account has been registered by the receipt of the registration of the account.

21. The method as defined in claim 13, wherein the determining whether the request is authorized by the account holder further comprises determining that the criteria received in the request is received from the logical address corresponding to the account holder.

22. The method as defined in claim 13, wherein the confirmation comprises a different said token that is:
not representative of the account issued by the issuer; and
sufficient for a different merchant to conduct a different transaction on an account corresponding to the token for a purchase of a good or service.

23. The method as defined in claim 13, wherein the steps further comprise:
receiving, the token and an evaluation of the one said merchant in the list; and
determining whether the transaction has been conducted by the account holder submitting the token to the one said merchant in the list; and
if the transaction has been conducted by the account holder submitting the token to the one said merchant in the list, storing, in a database, the evaluation so as to be associated with the one said merchant in the list, wherein the database contains a plurality of said merchants and their respective said evaluations submitted by other said account holders who had conducted respective said transactions with the plurality of said merchants.

24. The method as defined in claim 23, wherein the steps further comprise:
receiving a request containing an identifier for a merchant and a logical address;
determining whether the identifier for the merchant corresponds to at least one said merchant in the plurality of said merchants that are contained in the database; and
if the identifier for the merchant corresponds to at least one said merchant in the plurality of said merchants that are contained in the database, then sending, to the logical address, one or more said evaluations contained in the database that respectively correspond to the at least one said merchant in the plurality of said merchants that are contained in the database.

25. A non-transitory computer readable medium comprising instructions which, when executed by a computing apparatus, performs the method of claim 13.

26. A method comprising a plurality of steps each being performed by computing apparatus executing computer software, wherein the steps include:
receiving criteria in a request for a list of merchants each of whom can conduct a transaction on an account for a purchase of a good or service with an account holder, wherein the account is issued by an issuer to an account holder;
determining, using the criteria, whether the request is authorized by the account holder; and
if the request is authorized by the account holder:
retrieving, using the criteria, the list of merchants, wherein:
at least one of the merchants in the list satisfies the criteria; and
the list of merchants includes an offer from each said merchant in the list for a discount on the transaction conducted on the account by the account holder with the merchant;
sending, in response to the receiving of the request, the list of merchants to a logical address corresponding to the account holder;
receiving a selection of one said offer from one said merchant in the list;
sending to the logical address corresponding to the account holder, in response to the receiving of the selection of the offer from the one said merchant, a token that is:
representative of the account issued by the issuer to the logical address corresponding to the account holder; sufficient for the one said merchant in the list to conduct the transaction on the account for the purchase of the good or service; and
associated with the discount of the selected said offer from the one said merchant in the list;
receiving a transmission that includes an indicator that the token has been submitted to the one said merchant;
comparing the time that the transmission was received to the time that the token was sent to the logical address corresponding to the account holder to ascertain whether a difference from the comparison exceeds a predetermined time limit; and
if difference from the comparison is not greater than the predetermined time limit, sending a message to a logical address corresponding to the one said merchant in the list, wherein the message includes:
an authorization to conduct the transaction on the account for the purchase of the good or service; and
the discount of the selected said offer from the one said merchant in the list.

27. The method as defined in claim 26, wherein the steps further comprise:
receiving information confirming that the transaction has been conducted by the account holder submitting the token to the one said merchant in the list; and
sending a confirmation of the conducting of the transaction to the logical address corresponding to the account holder.

28. The method as defined in claim 26, wherein the request is received from the logical address corresponding to the account holder.

29. The method as defined in claim 26, wherein the token comprises a string of a number of characters that is different that the number of characters in a Primary Account Number (PAN) that identifies the account issued to the account holder.

30. The method as defined in claim 29, wherein the issuer of the account is the issuer of the token.

31. The method as defined in claim 26, wherein:
the token comprises a string of a number of integers that is the same number of integers in a Primary Account Number (PAN) that identifies the account issued to the account holder; and
the integers of the token are different than the integers of the PAN.

32. The method as defined in claim 31, wherein the issuer of the account is different than the issuer of the token.

33. The method as defined in claim 26, wherein:
the criteria comprises an identifier for a geographic location; and
the retrieving of the list of merchants further comprises:
accessing a database containing a plurality of said merchants and their respective geographic locations, wherein each of the merchants in the database can conduct the transaction on the account for the purchase of the good or service with the account holder; and
forming the list of merchants from the merchants in the database that have a geographic location within a predetermined distance from the geographic location corresponding to the identifier in the criteria.

34. The method as defined in claim 26, wherein:
the method further comprises, prior to the receiving of the criteria, receiving a registration of the account to receive one or more future issued said tokens; and
the determining whether the request is authorized by the account holder further comprises determining that the account has been registered by the receipt of the registration of the account.

35. The method as defined in claim 26, wherein the determining whether the request is authorized by the account holder further comprises determining that the criteria received in the request is received from the logical address corresponding to the account holder.

36. The method as defined in claim 26, wherein the confirmation comprises a different said token that is:
not representative of the account issued by the issuer; and
sufficient for a different merchant to conduct a different transaction on an account corresponding to the token for a purchase of a good or service.

37. The method as defined in claim 26, wherein the steps further comprise:
receiving, the token and an evaluation of the one said merchant in the list; and
determining whether the transaction has been conducted by the account holder submitting the token to the one said merchant in the list; and
if the transaction has been conducted by the account holder submitting the token to the one said merchant in the list, storing, in a database, the evaluation so as to be associated with the one said merchant in the list, wherein the database contains a plurality of said merchants and their respective said evaluations submitted by other said account holders who had conducted respective said transactions with the plurality of said merchants.

38. The method as defined in claim 37, wherein the steps further comprise:
receiving a request containing an identifier for a merchant and a logical address;
determining whether the identifier for the merchant corresponds to at least one said merchant in the plurality of said merchants that are contained in the database; and
if the identifier for the merchant corresponds to at least one said merchant in the plurality of said merchants that are contained in the database, then sending, to the logical address, one or more said evaluations contained in the database that respectively correspond to the at least one said merchant in the plurality of said merchants that are contained in the database.

39. A non-transitory computer readable medium comprising instructions which, when executed by a computing apparatus, performs the method of claim 26.

40. A method comprising a plurality of steps each being performed by apparatus executing instructions, wherein the steps include:
receiving a token representative of an account issued by an issuer to an account holder;
determining, using the token, whether the token had been submitted to a merchant as a payment on the account for a transaction conducted on the account for a purchase of a good or service;
if the token had been submitted to conduct the transaction:
receiving an evaluation of the transaction for the purchase of the good or service from the merchant; and
storing, in a database, the evaluation so as to be associated with the merchant, wherein the database contains a plurality of said merchants and their respective said evaluations submitted by other said account holders who had conducted respective said transactions with the plurality of said merchants.

41. The method as defined in claim 40, wherein the steps further comprise:
receiving a request containing:
an identifier for a merchant; and
a logical address;
determining whether the identifier for the merchant corresponds to at least one said merchant in the plurality of said merchants that are contained in the database; and
if the identifier for the merchant corresponds to at least one said merchant in the plurality of said merchants that are contained in the database, then sending, to the logical address, one or more said evaluations contained in the database that respectively correspond to the at least one said merchant in the plurality of said merchants that are contained in the database.

42. The method as defined in claim 40, wherein the token comprises a string of a number of characters that is different that the number of characters in a Primary Account Number (PAN) that identifies the account issued to the account holder.

43. The method as defined in claim 42, wherein the issuer of the account is the issuer of the token.

44. The method as defined in claim 40, wherein:
the token comprises a string of a number of integers that is the same number of integers in a Primary Account Number (PAN) that identifies the account issued to the account holder; and
the integers of the token are different than the integers of the PAN.

45. The method as defined in claim 44, wherein the issuer of the account is different than the issuer of the token.

46. A non-transitory computer readable medium comprising instructions which, when executed by a computing apparatus, performs the method of claim 40.
